(19) United States
(12) Patent Application Publication
(10) Pub. No.: US 2009/0238263 A1
(43) Pub. Date: Sep. 24, 2009

(54) Flexible field based energy efficient multimedia processor architecture and method

(76) Inventors: Pawan Jaggi, Plano, TX (US); Sandeep Kumar, Austin, TX (US); Xiaohui Wei, Richardson, TX (US)

Correspondence Address: George R. Schultz;Schultz & Associates, P.C., One Lincoln Centre, 5400 LBJ Freeway, Suite 1200, Dallas, TX, 75240, US

(21) Appl. No.: 12/322,721

(22) Filed: Feb. 6, 2009

Related U.S. Application Data
(60) Provisional application No. 61/070,122, filed on Mar. 20, 2008.

(51) Int. Cl. H04N 7/30; H04N 7/26

(52) U.S. Cl. 375/240.2; 375/240.18; 375/E07.226

(57) ABSTRACT

A programmable energy efficient codec system is provided for encoding and decoding a plurality of application environments. A camera Codec and control system for an HD camera is provided for encoding uncompressed HD-SDI video signals into an MPEG-2 transport stream. A stand-alone encoder decoder system is provided in a network configuration allowing for remote display and editing of HD-SDI video. At least one plurality of HD-SDI transport streams is generated from HD-Cameras encoded into MPEG-2 transport streams and output into a DVD-ASI signal and a TS/IP packet stream further provided is a decoder which accepts MPEG-2-TS/IP packet streams from a routed IP network which are decoded into an uncompressed HD-SDI transport stream for display. A set top box is provided for decoding audio and video HD-TV. A first HDMI interface into the decoder allows acceptance of an MPEG-2-TS from local storage media. Connection to an IP routed network is provided. The set top box may also request product specific decoder algorithms from a centralized manager. A kernel is provided in software which enables dramatic power reduction and ease of system update.

### CROSS-REFERENCE TO RELATED APPLICATIONS

This application claims priority to U.S. Provisional Application No. 61/070,122 filed Mar. 20, 2008.

### TECHNICAL FIELD OF THE INVENTION

This invention relates to a system and method for encoding video signals or files from a video transport stream or raw video data file, respectively, into a constant bit rate high level MPEG-2 ISO/IEC compliant transport stream.

### BACKGROUND OF THE INVENTION

The challenges created by the ever evolving video encoding and transport standards force new generations of video equipment that customers have to manage, control and continue to invest in. Expensive equipment purchased by video product manufacturers such as a professional HD camera manufacturer has to be removed and replaced by equipment built for new standards. To manage in this environment advanced but economical video compression techniques are required to store or transmit video. Furthermore, a dynamic platform is required to accommodate the ever evolving standards in order to reduce equipment churn.

Conventional approaches require complex ASICS or arrays of DSPs to manage the intensive signal processing which reduces flexibility, comprises quality and adds non-recurring engineering costs inherent in ASIC production. What is needed is a high performance, high speed, low cost hardware platform in combination with software programmability so that future video signal processing standards may be incorporated into the platform as those standards evolve.

U.S. Pat. No. 7,317,839 entitled “Chroma Motion Vector Derivation for Interlaced Forward-Predicted Fields” to Holcomb discloses a digital video bitstream producing method for computer by outputting encoded video data & controls to control post-processing filtering video data after decoding.

U.S. Patent Publication No. 2002/0041632 entitled “Picture Decoding Method and Apparatus” to Sato, et al. discloses an MPEG decoder for digital television broadcasting that has activity compensation for reverse orthogonal transformation image based on reference image.

U.S. Pat. No. 6,434,196 entitled “Method and Apparatus for Encoding Video Information” to Sethuraman, et al. discloses a video information encoding system for communication and compression system that employs Micro-block sectioning.

U.S. Pat. No. 5,973,740 entitled “Multi-Format Reduced Memory Video Decoder with Adjustable Polyphase Expansion Filter” to Hrusecky discloses expanding decimated macroblock data in digital video decoding system with coding for both field and frame structured coding.

The present invention addresses the need for a programmable video signal processor through a combination of a hardware and dynamic software platform for video compression and image processing suitable for broadcast level high definition (HD) video encoding, decoding and imaging. The dynamic software platform is implemented on a low cost multicore DSP.

### SUMMARY OF INVENTION

The present invention is a programmable energy efficient codec system with sufficient flexibility to provide encoding and decoding functions in a plurality of application environments.

In one application of the present invention, a camera codec and control system for an HD-Camera is envisioned wherein a first embodiment hosted codec subsystem encodes raw uncompressed HD-SDI video signals from the camera's optical subsystem into an MPEG-2 transport stream. A host system in the HD-camera stores the MPEG-2 transport stream on storage media onboard the HD-camera. The host system also exchanges status and control with the first embodiment codec subsystem. Raw uncompressed audio and video files may be passed through the codec susbsystem and stored by host system for subsequent processing. The codec susbsystem may be programmed to encode or decode a plurality of video and audio format as required by multiple HD-camera manufacturers.

In a second application of the present invention, a standalone encoder system and stand alone decoder system is assembled into a network configuration suitable for studio production system allowing for remote display and editing of HD-SDI video. The stand alone encoder and decoder utilize a second embodiment codec subsystem. At least one of a plurality of HD-SDI transport streams generated from a plurality of HD-cameras is encoded into an MPEG-2 transport stream which is output by the stand alone encoder into a DVB-ASI signal and a TS over IP packet stream, the latter being suitable for MPEG-2 transport over a routed IP network. The stand alone decoder accepts MPEG-2 TS over IP packet streams from a routed IP network and decodes them into uncompressed HD-SDI transport stream useful for display. The MPEG-2 transport stream arriving at the stand alone decoder may be generated by a stand alone encoder on site to the studio production. A local workstation may accept DVB-ASI signals from the encoder for local video editing and storage. A remote workstation may accept TS/IP MPEG-2 files for remote video storage, decoding and editing. The codec subsystem may be programmed to encode or decode a plurality of video and audio format as required by multiple studio production houses.

In a third representative application of the present invention, a third embodiment code subsystem is embedded in a set top box for decoding audio and video for HDTV in a home environment. A first HDMI interface into the decoder allow the decoder to accept MPEG-2 TS from local storage media such a BLU-ray disk player. A second HDMI interface out of the decoder allows the set top box to play and display decoded audio and video. The code system of the set top box is connected to an IP routed network such as the internet by two high speed Ethernet ports, one port dedicated for transport TS/IP packet streams and the other port dedicated for management applications, for example applications related to rights management. A centralized manager is connected to the set top box by an IP routed network. One set of content providers may be in communication with the centralized manager and a second set of content providers may be in communication with the set top box via the IP routed network. In one aspect of the invention, the set top box may request product specific decoder algorithms from the centralized manager or directly from the content providers, the product specific decoder algorithms being downloaded into the set top box and utilized to accomplish the decoding function for a video product. In another aspect of the invention, the set top box based codec system may accept MPEG-2 transport streams via the IP routed network and play/display HDTV video directly after decoding said MPEG-2 transport streams.

The embodiments described have hardware systems based on a field programmable set of hardware including a DSP, a HD-SDI and SD-SDI multiplexer/demultiplexer, an MPEG-2 compatible transport stream multiplexer/demultiplexer, a boot controller, and a set of external interface controllers. In one embodiment of the codec system, the set of external interface controllers includes a PCI controller for a PCI bus interface. In a second embodiment codec system, the set of external interface controllers includes a panel interface controller for accepting input from a keypad, displaying output on a LCD display screen and communicating alarm information through a digital interface. In a third embodiment codec system, the set of external interface controllers includes a panel interface controller for accepting input from a remote control device, displaying output on a LCD display screen and accepting input from user control buttons. Additionally, the third embodiment codec system has a display controller for driving an HDMI interface suitable for HDTV display.

The software framework of the many embodiments of the present invention has the capability to intelligently manage system power consumption through a systems energy efficiency manager (SEEM) kernel which is programmed to interact with various software modules, including modules that can adaptively control system voltage. The SEEM kernel monitors required speed and required system voltage while in different operational modes to ensure that required speed and voltage are maintained at minimum necessary levels to accomplish required operations. The SEEM kernel enables dramatic power reduction over and above efficient power designs chosen in the hardware systems architecture level, algorithmic level, chip architecture level, transistor level and silicon level optimizations.

To accommodate the SEEM kernel and to allow for ease of system update and upgrade, and ease of development of a variety of different systems or encoder/decoder algorithms, the DSP based software framework utilizes a dual operating system environment to run system level operations on a system OS and to run computational encoder/decoder level operations on a DSP OS. A system scheduler manages the operations between the two OS environments. A set of system library interfaces are utilized for external interface functions and communications to peripherals allowing for a set of standard APIs to be available to host systems when the codec is in a hosted environment. A set of DSP library interfaces allow for novel DSP intensive encoder functions relating to operations such as discrete cosine transformations, motion estimation, quantization matrix manipulations, variable length encoding functions and other compression functions.

These and other inventive aspects will be described in the detailed description below.

### BRIEF DESCRIPTION OF DRAWINGS

The disclosed inventions will be described with reference to the accompanying drawings, which describe important sample embodiments of the invention and which are incorporated in the specification hereof by reference, wherein:

FIGS. 1a and 1b are schematic diagrams of a HD-Camera codec system application in the first embodiment.

FIG. 2 is a schematic diagram of stand alone codec system application for a studio quality video production environment in the second embodiment.

FIG. 3 is a schematic diagram of a stand alone codec system application for a home theatre remote networked environment in the third embodiment.

FIG. 4 is block diagram of the hardware functionality of the first embodiment codec system.

FIG. 5 is a block diagram showing of the efficient multimedia platform system.

FIG. 6 is block diagram showing the software architecture including data and control flow of the codec system.

FIG. 7 is a state diagram indicating the states of the codec software system.

FIG. 8 is a block diagram showing an overview of the recording function of the first embodiment codec system.

FIG. 9 is a block diagram showing an overview of the playback function of the first embodiment codec system.

FIG. 10 is block diagram of the hardware functionality of the second embodiment codec system.

FIG. 11 shows a front and rear perspective of an encoder box in the second embodiment.

FIG. 12 shows a front and rear perspective of a decoder box in the second embodiment.

FIG. 13 is block diagram of the hardware functionality of the third embodiment codec system.

FIG. 14 is block diagrammatic view of the construction of field subblocks for field based encoding and decoding.

FIG. 15 is a table of preferred encoder modes of the codec system.

FIG. 16 is a block diagram of a MPEG-2 record video packet format.

FIG. 17 is a table showing the detail of the MPEG-2 record video packet format.

FIG. 18 is a set of tables showing the host software API commands, encoder revisions information and operating modes.

FIG. 19 is a table showing the host software API encoder control functions.

FIG. 20 is a table showing the host software API encoder video source control options.

FIG. 21 is a block diagram showing the primary functions of the system energy efficiency manager kernel.

FIG. 22 is a block diagram of the components of the system energy efficiency manager kernel.

FIG. 23a is a block diagram of a network release center in a fourth embodiment application.

FIG. 23b is a block diagram of a network head end in the fourth embodiment application.

### DETAILED DESCRIPTION

The flexible video processor of the present invention may be implemented in a variety of embodiments in different application environments incorporating hardware platforms suitable to the environment. Three particular application environments including high definition camera hardware, high definition video production and HDTV consumer set top box are described along with corresponding embodiments of the flexible video processor. Many other applications and embodiments of the present invention may be conceived so that the inventive ideas disclosed in relation to the given applications are not to be construed as limiting the invention.

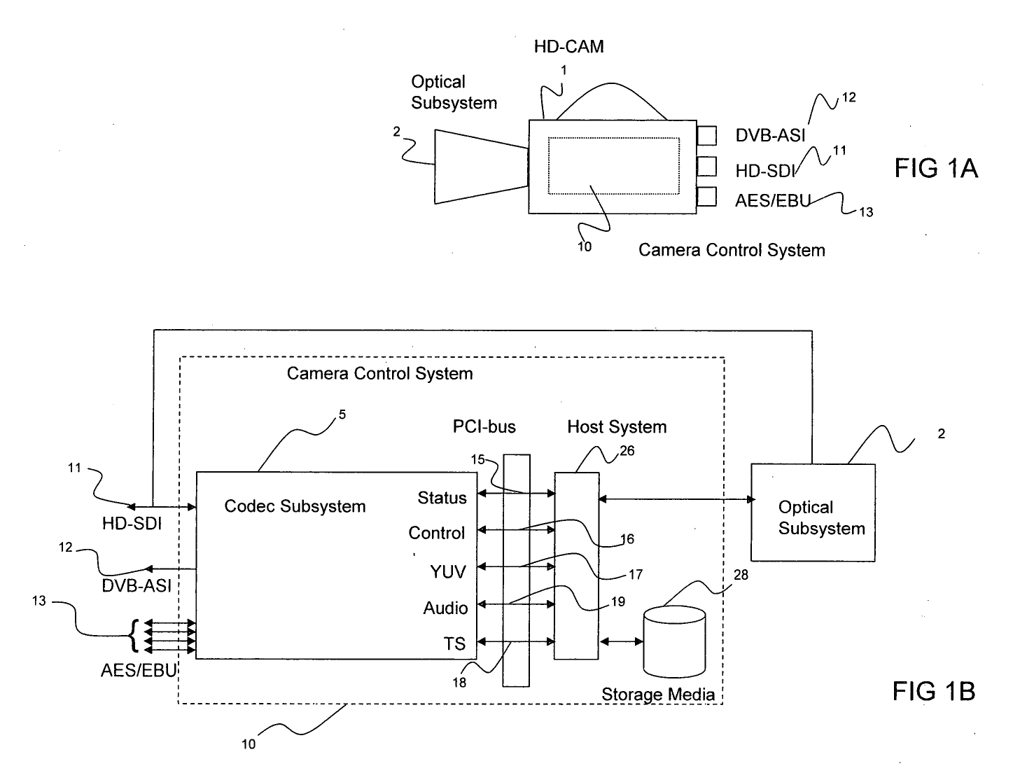

A first application of the present invention is in a high definition video production camera as shown in FIGS. 1A and 1B. In FIG. 1A, HD camera 1 comprises optical subsystem 2 and camera control system 10 and has external interfaces of at least one DVB-ASI interface 12, a set of AES/EBU standard audio channel interfaces 13 and a HD-SDI interface 11. Other controls not shown may exist on the HD camera to control its optical and electronic functions. The camera control system 10 is depicted in FIG. 1B comprising codec subsystem 5 and host subsystem 26 with storage media 28 attached thereto. Codec subsystem 5 and host subsystem 26 exchange data via PCI bus interface 27. Under control of host system 26, optical subsystem 2 functions to focus and control light, sense light, digitize and stream uncompressed HD-SDI signal 8 according to the SMPTE 292M standard. Codec subsystem 5, which is the object of the present invention, functions to encode HD-SDI signal 8 recording compressed audio/video files 18 onto storage media 28 via PCI bus interface 27 and host subsystem 26. Stored compressed audio/video files 18 from host subsystem 26 may also be decoded and played back through codec subsystem 5. Audio encoded in stored compressed audio/video files 18 may be played back through the AES/EBU port 13 which is typically a 4 channel 8 wire interface.

Codec susbsystem 5 interfaces to host subsystem 26 through PCI bus 27 to allow for control signals 44 and status signals 45 to flow between the two subsystems. In the encoder mode of operation, the input video/audio stream for codec subsystem 5 is demultiplexed and encoded from uncompressed HD-SDI signal 8. A MPEG-2 transport stream (TS) encoded by codec subsystem 5 is sent to DVB-ASI interface 12 and also forms compressed audio/video files 18 with record headers documenting format information and content metadata if required.

Uncompressed HD-SDI signal 8 may also be demultiplexed and stored as raw YUV video data files 17 and raw audio data files 19 in storage memory 28. Uncompressed raw data files allow for future editing and processing without loss of information that occurs during the encoding and compression processes. Codec subsystem 5 may playback raw video and audio data files to the HD-SDI interface 11 and AES/EBU port 13, respectively.

Codec subsystem 5 is implemented on a digital signal processor and may be programmed to support a variety of encoding, decoding and compression algorithms.

The HD camera application illustrates an example of a first embodiment of the present invention that utilizes a codec system, host system and PCI bus between the two systems to perform video encoding and decoding operations. The host system need not be embedded as in the HD-camera 1, but may be a computer system wherein the codec subsystem may be a physical PCI card connected to the computer. Novel encoding and decoding operations of the present invention will be described in greater detail. A commercial example of the first embodiment codec system is the HCE1601 from Ambrado, Inc.

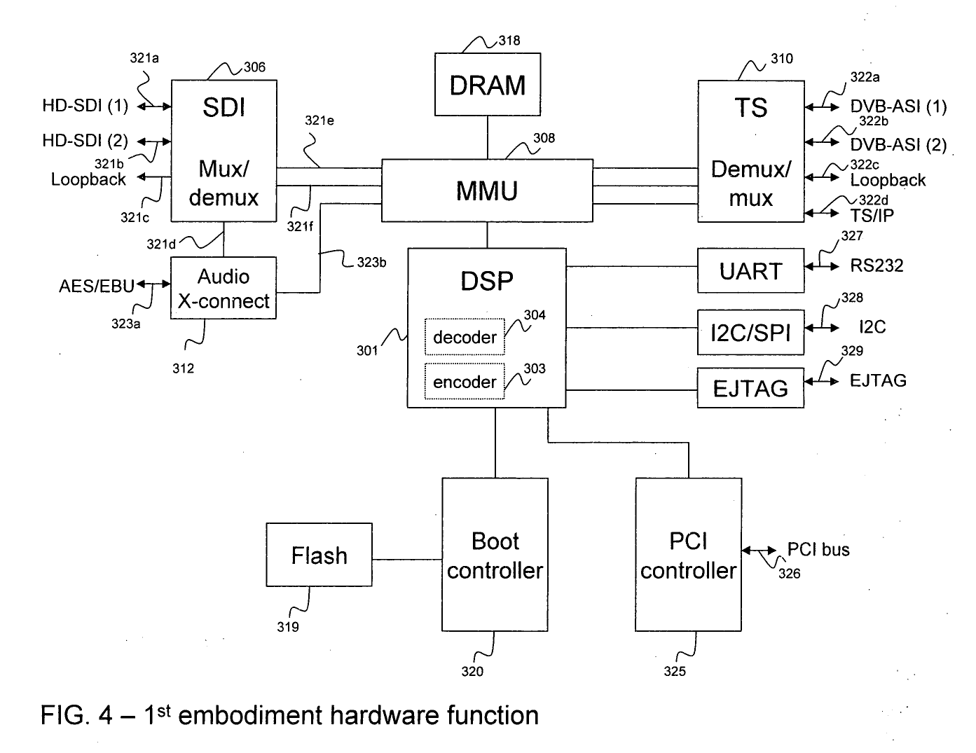

Moving to the block diagram of FIG. 4, codec system 300 of the first embodiment of the present invention comprises a DSP processor 301 to which memory management unit MMU 308, a SDI mux/demux 306, a transport stream (TS) mux/demux 310 and an audio crossconnect 312 are attached for processing video and audio data streams. DSP microprocessor 301 implements video/audio encoder functions 304 and video/audio decoder functions 303. DSP microprocessor 301 has interfaces RS232 PHY interface 327 for external control interface, I2C and SPI load speed serial interfaces for peripheral interfacing, EJTAG interface 329 for hardware debugging and a PCI controller 325 for controlling a PCI bus interface 326 to a host system. Boot controller 320 is included to provide automatic bootup of the hardware system, boot controller 320 being connected to flash memory 319 which holds program boot code, encoder functional code and decoder functional code which may be executed by DSP microprocessor 301.

DSP microprocessor 301 is a physical integrated circuit with CPU, I/O and digital signal processing hardware onboard. A suitable component for DSP microprocessor 301 having sufficient processing power to successfully implement the embodiments of the present invention is the SP16 Storm-1 SoC processor from Stream Processors Inc.

MMU 308 provides access to dynamic random access memory (DRAM 318) for implementing video data storage buffers utilized by SDI mux/demux 306 and TS mux/demux 310 for storing input and output video and audio data. SDI mux/demux 306 has external I/O ports HD-SDI port 321a, HD-SDI port 321b, HD-SDI loopback port 321c, and has internal I/O connections to DRAM 318 through MMU 308 including embedded video I/O 321e and embedded metadata I/O 321f. SDI-mux/demux may stream digital audio to and from audio crossconnect via digital audio I/O 321d. A set of external AES/EBU audio ports 323a-d is also connected to audio crossconnect 312 which functions to select from the signal on audio ports 323a-d or the signal on digital audio I/O port 321d for streaming to DRAM 318 through MMU 308 on embedded audio connection 323b.

Transport stream mux/demux 310 has DVB-ASI interfaces 322a, 322b and DVB-ASI loopback interface 322c. TS mux/demux 310 may also generate or accept TS over IP data packets via 10/100/1000 Base-Tx Ethernet port 322d. TX mux/demux 310 conveys MPEG-2 transport streams in network or transmission applications. MPEG-2 video data streams may be stored and retrieved by accessing DRAM 318 through MMU 308.

MMU 308, SDI mux/demux 306, TS mux/demux 310 and audio crossconnect 312 functions are preferably implemented in programmable hardware such as a field programmable gate array (FPGA). Encoder and decoders are implemented in reprogrammable software running on DSP microprocessor 301. Boot controller 320 and PCI controller 325 are implemented as system control programs running on DSP microprocessor 301.

To implement an encoder, DSP microprocessor 301 operates programmed instructions for encoding and compression of an SMPTE 292M standard HD-SDI transport stream into a MPEG-2 transport stream. SDI mu/demux 306 is programmed to operate as a SDI demultiplexer on input transport streams from HD-SDI I/O ports 321a and 321b with output embedded video and audio streams placed in video and audio data buffers implemented in DRAM 318, TS mux/demux 310 is programmed to operate as a TS multiplexer, taking its input audio and video data stream from DRAM 318 and streaming its multiplexed transport stream selectably to DVB-ASI port 322a, DVB-ASI port 322b or TS over IP port 322d. Video and audio encoder running on DSP microprocessor 301 accesses stored video and audio data streams in DRAM 318 to perform the encoding and compression functions.

To implement a decoder, DSP microprocessor 301 operates programmed instructions for decompression and decoding of a MPEG-2 transport stream into an SMPTE 292M HD-SDI transport stream. SDI mux/demux 306 is programmed to operate as a SDI multiplexer with output transport streams sent to HD-SDI I/O ports 321a and 321b with input embedded video and audio streams captured from video and audio data buffers implemented in DRAM 318, TS mux/demux 310 is programmed to operate as a TS demultiplexer, sending its output audio and video data stream to DRAM 318 and streaming its input transport stream selectably from DVB-ASI port 322a, DVB-ASI port 322b or TS over IP port 322d. Video and audio decoder running on DSP microprocessor 301 accesses stored video and audio data streams in DRAM 318 to perform the decompression and decoding functions.

In the preferred embodiment DRAM 318 is shared between a host system connected through PCI bus 326 and codec system 300.

The hardware platform being centered around a DSP processing engine are flexible and extendable to input interfaces and bit rates, video framing formats, compression methods, file storage standards, output interfaces and bit rates and to given user requirements per a given deployed environment so that many further embodiments are envisioned by adjusting the firmware or software programs residing on either given hardware platform.

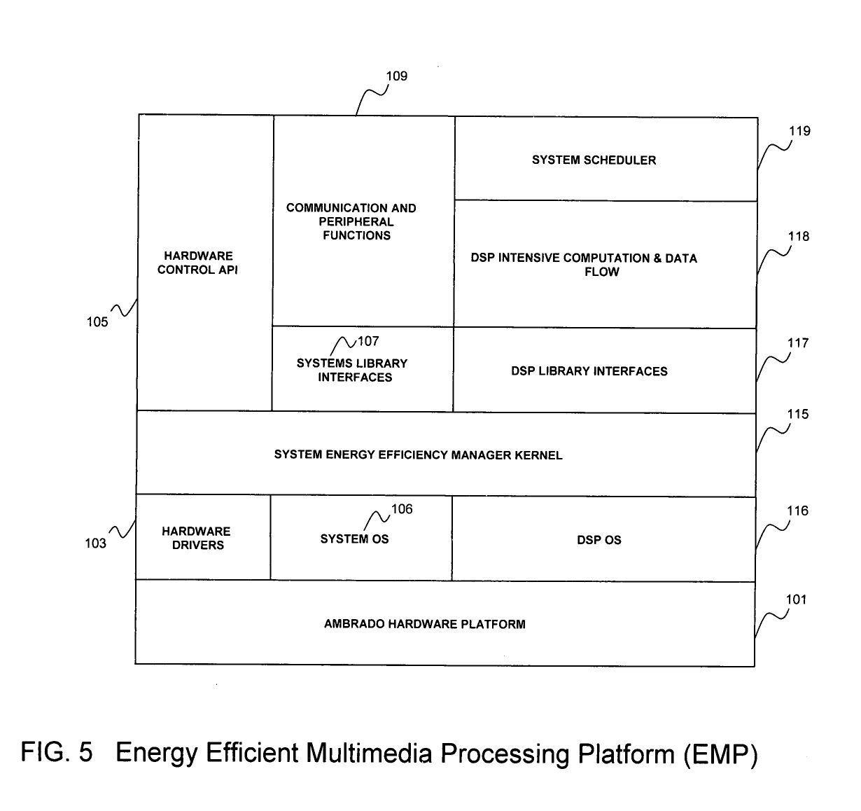

The software framework and programmable aspects of the present invention are explained with the help of FIGS. 5, 6 and 7. Codec software system, described by the software framework 100 of FIG. 5, operates on hardware platform 101 which has functional components consistent with first embodiment codec system 300 of FIG. 4. Software framework 100 executes under a pairing of two operating systems, the system OS 106 and the DSP OS 116, running on DSP microprocessor 301 in codec system 300. In the preferred embodiment, the system OS is an embedded Linux OS and the DSP OS is RTOS. Under these two operating systems, Codec software framework 100 comprises a set of modules that permit rapid adaptation to changing standards as well as customization to users specific needs and requirements with a short development cycle.

Software framework 100 has the capability to intelligently manage system power consumption through systems energy efficiency manager (SEEM) kernel 115 which is programmed to interact with various software modules, including modules that can adaptively control system voltage. SEEM kernel 115 monitors required speed and required system voltage while in different operational modes to ensure that required speed and voltage are maintained at minimum necessary levels to accomplish required operations. SEEM kernel 115 enables dramatic power reduction over and above efficient power designs chosen in the hardware systems architecture level, algorithmic level, chip architecture level, transistor level and silicon level optimizations.

System OS 106 further interfaces to a set of hardware drivers 103 and a set of hardware control APIs 105 and forms a platform that utilizes systems library module 107 along with the communications and peripheral functions module 109 to handle the system work load. Systems library module 107 contains library interfaces for functions such as video device drivers and audio device drivers while communications and peripheral functions module 109 contains functions such as device drivers for RS232 interfaces and panel control functions if they are required. System OS 106 also handles the system function of servicing the host interface in a hosted environment, the host interface physically being PCI controller 325 controlling PCI bus interface 326 in first embodiment codec system 300.

DSP OS 116 handles the execution of DSP centric tasks and comprises DSP library interfaces 117, DSP intensive computation and data flow 118, and a system scheduler 119. Examples of DSP centric tasks include codec algorithmic functions and video data streaming functions. The system scheduler 119 manages thread and process execution between the two operating systems.

Software framework 100 is realized in the embodiments described herein and is named in corresponding products from Ambrado, Inc as the Energy Efficient Multimedia Processing Platform (EMP).

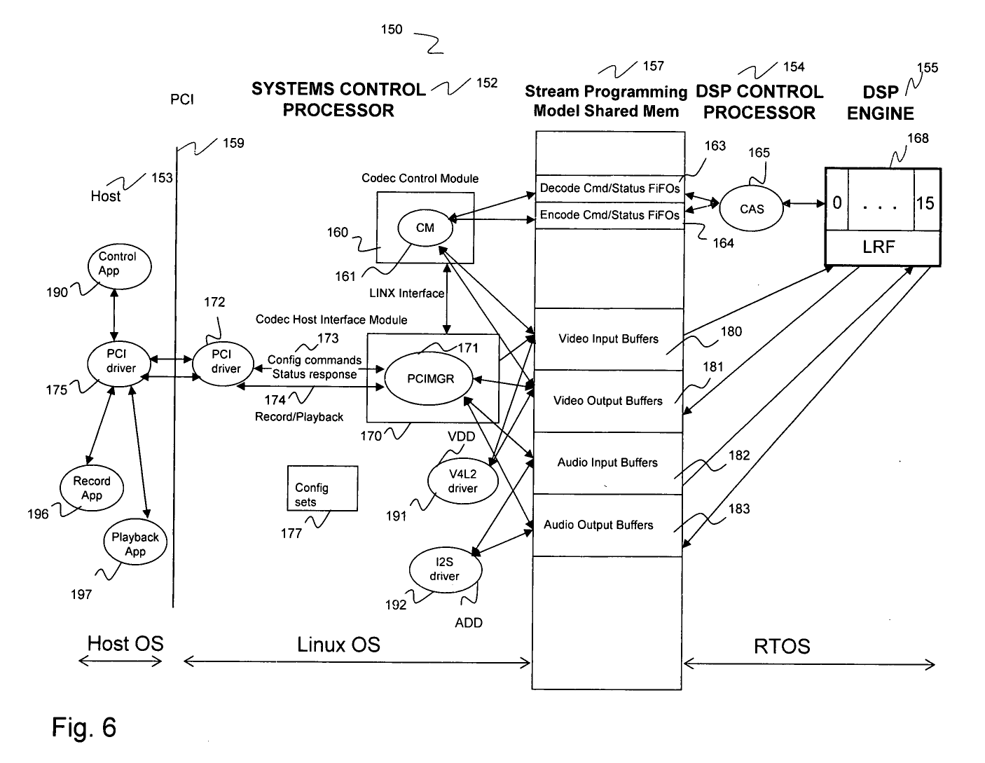

Codec software system of software framework 100 is organized into a set of modular components which are shown in FIG. 6. Components in the architecture represent functional areas of computation that map to subsystems of processes and device drivers, each component having an associated set of responsibilities and behaviors as well as support for inter-component communication and synchronization. Components do not necessarily map directly to a single process or single thread of execution. Sets of processes running on the DSP processor typically implement responsibilities of a component within the context of the appropriate OS. The principal components of the codec software system of the present invention are a codec manager, a PCI manager, a Codec Algorithmic Subsystem (CAS), a video device driver (VDD) and an audio device driver (ADD).

Examining FIG. 6 in detail, codec software system 150 is comprised of systems control processor 152 operating within system OS 106 and utilizing programs running therein; DSP control processor 154 operating within DSP OS 116 and utilizing programs running therein; DSP engine 155 executing streams of instructions as they appear in the lane register files 168; a stream programming shared memory 157, which is memory shared between System OS 106 and DSP OS 116 so that data may be transferred between the two operating systems.

A host system 153 interacts with codec software system 150 via PCI bus interface 159, host system 153 comprising at least a PCI driver 175 for driving data to and from PCI bus interface 159, a user driven control application 190 for controlling codec functions, a record application 196 for recording video and audio in conjunction with codec system 150 and a playback application 197 for playing video and audio files in conjunction with codec system 150. Host system 153 is typically a computer system with attached storage media that operates programs under Microsoft Windows OS. Alternatively, the host operating system may be a Linux OS.

Systems control processor 152 operates principal system components including codec manager 161, PCI manager 171, video device driver VDD 191 and audio device driver ADD 192. Codec manager 161 is packaged as a set of methods programmed in codec control module 160. PCI manager 171 is packaged as a set of methods programmed in codec host interface module 170.

DSP control processor 154 operates a codec algorithmic subsystem CAS 165 which is a principal system component.

Shared memory 157 comprises memory containers including at least a decode FIFO stack 163 and an encode FIFO stack 164 for holding command and status data, a video input buffer 180 for holding ingress video stream data, a video output buffer 181 for holding egress video stream data, an audio input buffer 182 for holding ingress audio stream data and an audio output buffer 183 for holding egress audio stream data.

VDD 191 and ADD 192 principal components are standard in embedded processing systems, being realized by the Linux V4L2 video driver and the Linux I2S audio driver in the preferred embodiment. VDD 191 manages the video data input and output requirements of codec system 150 as required in the course of its operation, operating on the video output buffer to create egress video streams for direct video interfaces and operating on ingress video streams from direct video interfaces to store video streams in video input buffer 180. Similarly, ADD 192 handles the codec system's audio input and output requirements operating on the audio input and output buffers to store and retrieve audio streams, respectively.

PCI manager 171 communicates all codec management and control tasks between host system 153 and codec manager 161 via PCI bus interface 159 using PCI driver 172. More specifically, PCI manager 171 communicates configuration commands 173a and status responses 173b in addition to record/playback commands 174 to and from host system 153.

PCI manager 171 transfers ingress video and audio streaming data generated from host system 153 into video input buffer 180 and audio input buffer 182, respectively. It also transfers egress video and audio streaming data to host system 153 from the video output buffer 181 and audio output buffer 183, respectively.

For configuration programming, PCI manager 171 allows host system 153 to exercise broad or finely tuned control of the codec functions. With a broad control approach, host system 153 configures the codec system 150 with stored configuration groupings known as configuration sets 177 of which there are three primary types in the preferred embodiment: (a) factory default configuration, (b) default configuration and (c) current configuration and an array of user definable configuration sets. In the preferred embodiment there are sixty-four user definable configuration sets in the array. With the finely tuned control approach, host system 153 may change any of the configuration settings in the current configuration allowing for a flexible model for codec configuration management for a plurality of encoding and decoding requirements.

Codec algorithmic subsystem CAS 165 performs encoding and decoding of video and audio data. CAS 165 is made up of kernels implementing MPEG-2 encoding and decoding algorithms for both audio and video which are executed by DSP control processor 154 in conjunction with DSP engine 155 by manipulating and performing computations on the streams in the lane register files 168. CAS 165 receives its commands and responds with status data to decode FIFO stack 163 and encode FIFO stack 164.

Codec manager 161 manages user interfaces and communicates configuration and status data between the user interfaces and the other principal components of the codec system 150. System interfaces are serviced by the codec manager 161 including a command line interface (not shown) and PCI bus interface requests via PCI manager 171. Codec manager 161 is also responsible for configuration data validation such as range checking and dependency checking.

Codec manager 161 also performs hierarchical scheduling of encoding and decoding processes, ensuring that encoding and decoding processes operating on incoming video and audio streams get appropriate CPU cycles. Codec manager 161 also schedules the video and audio streams during the encoding and decoding processes. To perform these scheduling operations, Codec manager 161 communicates directly with Codec algorithmic subsystem 165. For encoding (and decoding) operations, codec manager 161 accepts configuration data from the host control application 190 (via PCI manager 171) and relays video encoding (decoding) parameters to CAS 165 using encode FIFO 164 (decode FIFO 163). Codec manager 161 also collects status updates on the operational status of CAS 165 during encoding (decoding) process phases, communicating status information to host system 153 as required. Another function of Codec manager 161 is to interact with the video input buffer 180 to keep CAS 165 input stream full and to interact with the video output buffer 181 to ensure enough output buffer storage for CAS 165 to dump processed video data without overrun.

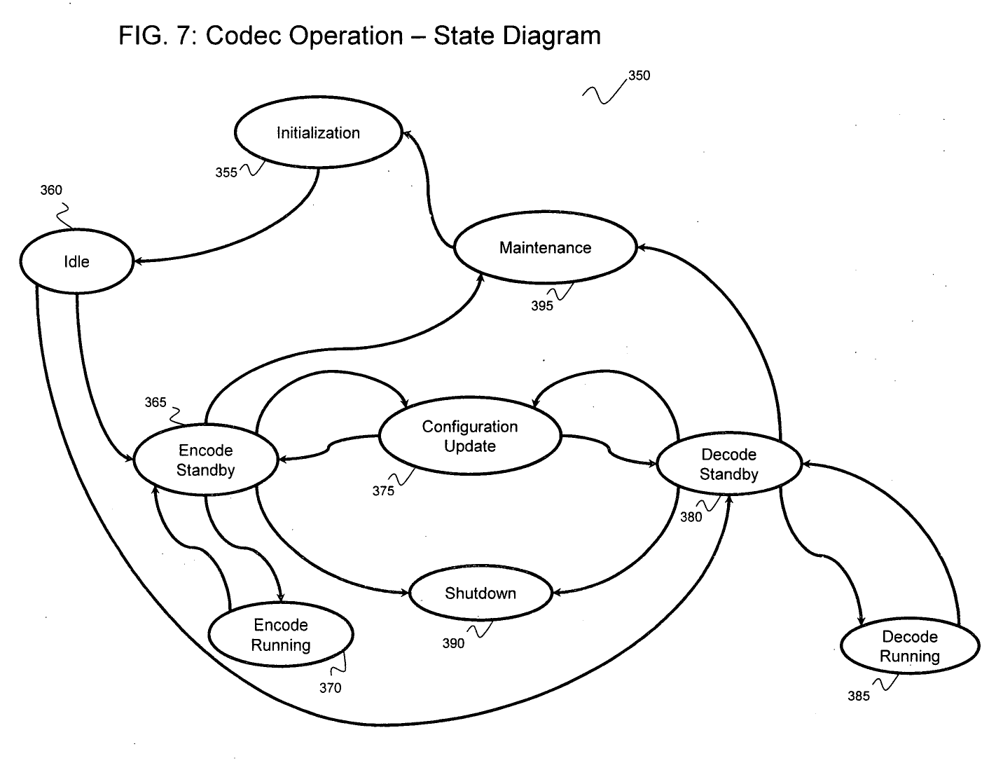

In operation, codec system 150 follows a sequence of operational states according to the state diagram 350 of FIG. 7. Interactions with codec system 150 to program the configuration and to change the operational mode causes codec system 150 to transition between the different operational states of FIG. 7.

Codec system 150 starts from the initialization state 355 while booting without any host system interaction. The system may be put into this state by sending an “INIT” command from PCI manager 171 to codec manager 161. During the initialization state the codec system boots, loading program instructions and operational data from flash memory. Once initialization is complete, codec system 150 transitions automatically to idle state 360, wherein the codec system is operational and ready for host communication. Codec manager 161 keeps the codec system in idle state 360 until a “start encode” or “start decode” command is received from the PCI manager 171. From idle state 360, the codec system may transition to either encode standby state 365 or decode standby state 380 depending upon the operational mode of the codec system being configured to encode or decode, respectively, according to the current configuration set.

Upon entering encode standby state 365, the codec system loads an encoder algorithm and is ready to begin encoding immediately upon receiving a “start encode” command from the host system via the PCI manager. When the “start encode” command is received by the codec manager, the codec system transitions from encode standby state 365 to encode running state 370. Encode standby state 365 may also transition to configuration update state 375 or to shutdown state 390 upon a configuration change request or a shutdown request from the host system, respectively. One other possible transition from encode standby state 365 is to maintenance state 395.

Encode running state 370 is a state in which the codec system, specifically the CAS 165, is actively encoding video and audio data. The only allowed transition from encode running state 370 is to encode standby state 365.

When entering decode standby state 380, the codec system loads a decoder algorithm and is ready to begin decoding immediately upon receiving a “start decode” command from the host system via the PCI manager. When the “start decode” command is received by the codec manager, the codec system transitions from decode standby state 380 to decode running state 385. Decode standby state 380 may also transition to configuration update state 375 or to shutdown state 390 upon a configuration change request or a shutdown request, respectively, from the host system. One other possible transition from decode standby state 380 is to maintenance state 395.

Decode running state 385 is a state in which the codec system, specifically the CAS 165, is actively decoding video and audio data. The only allowed transition from decode running state 385 is to decode standby state 380.

In configuration update state 375 a new configuration set is selected to be the current configuration set or the current configuration set is altered by the PCI manager. The only allowed transitions from the configuration update is to encode standby state 365 or decode standby state 380, depending upon the configuration setting.

Transitions to maintenance state 395 only arrive from encode standby state 365 or decode standby state 380 when a major codec system issue fix or a software update is required. The software update process is managed by the PCI manager. The only possible transition from maintenance state 395 is to initialization state 355.

Transitions to shutdown arrive from encode state 365 or decode standby state 380 upon a power down request from PCI manager, wherein the codec system promptly powers down.

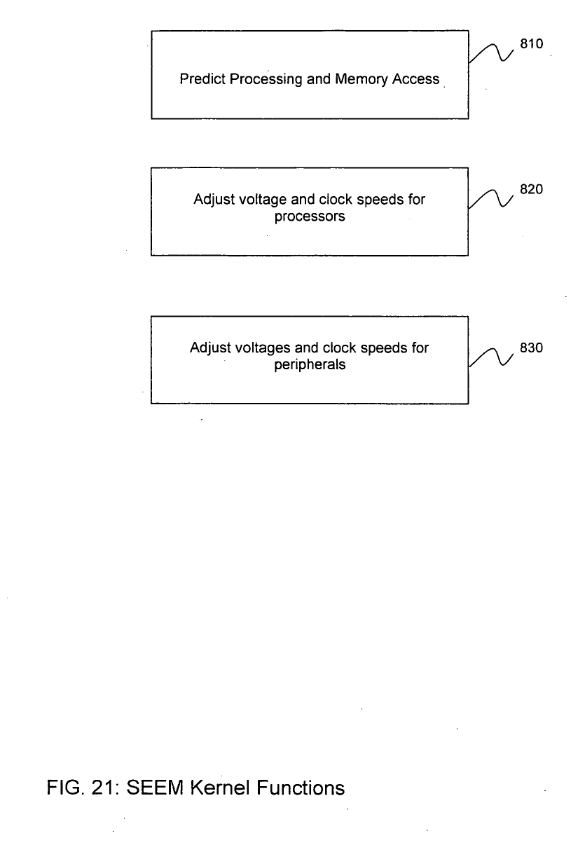

Energy efficiency of the codec system is managed in relation to the operational states of FIG. 7. SEEM kernel 115 of the codec software framework has three basic functions which are indicated in FIG. 21. Prediction function 810 proactively predicts processing and memory access requirements by different software components in operational phases to be executed, such as in playback or record operations. Processor adjustment function 820 adjusts voltage levels and clock speeds to processor elements in order to minimize necessary power in the operational phases. Peripheral adjustment function 830 adjusts voltage levels and clock speeds for peripheral devices as required by the operational phases.

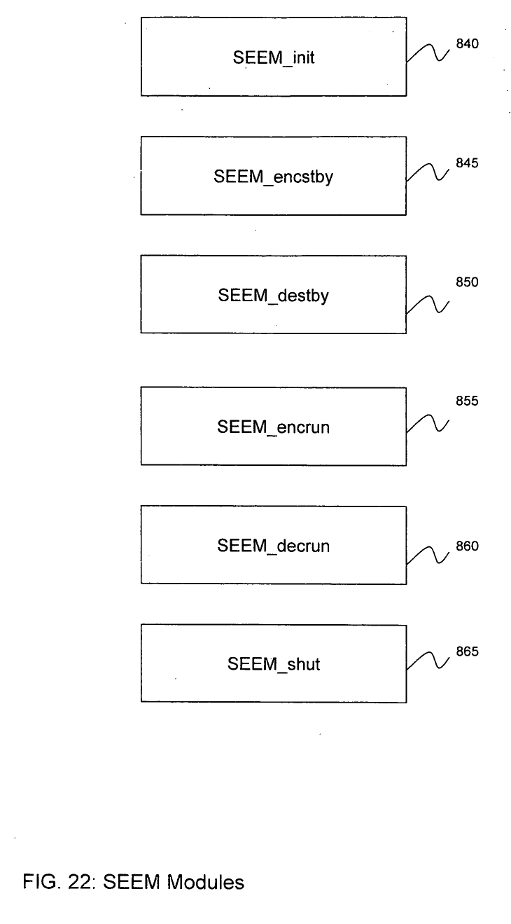

SEEM kernel 115 is examined in greater detail with the help of FIG. 22 which shows the executable SEEM components comprising SEEM kernel 115. Each SEEM component is associated to an operational state or to a transition between two operational states of the codec system.

SEEM_init 840 is a SEEM component that runs when the system is in initialization state 355 to parse all operational parameters passed to the system and based on impending operational requirements executes the following tasks:

i. initializes the voltage for the system to commence operation

ii. initializes the requisite clock speed

iii. idles all processor resources not required

iv. powers down and turns off the clocking signals to all peripherals not required

SEEM_encstby 845 is a SEEM component executing tasks similar to SEEM_init, except that it handles these tasks as operational/parametric requirements change during the transition from encode running state 370 to encode standby state 365 and back to encode running state 365. An example of a parametric change that changes operational requirements affecting power is when the encoder mode is changed from I-frame only encoding to LGOP frame encoding. Another relevant example is in when the constant bit rate requirement is changed from one output CBR rate to a different output CBR rate.

SEEM_destby 850 is a SEEM component executing tasks similar to SEEM_init, except that it handles these tasks as operational/parametric requirements change during the transition from decode running state 385 to decode standby state 380 and back to decode running state 385.

SEEM_encrun 855 is a SEEM component executing tasks similar to SEEM_init, except that it handles these tasks dynamically as needed while the codec system is in encode running state 365. For example, while a discrete cosine transform (DCT) is being computed the processor clock speed is increased by SEEM_encrun 855. Upon completion of the DCT, the encoder algorithm moves to a data transfer intensive mode that does not require processor cycles. SEEM_encrun 855 then idles the processor by reducing its clock rate and/or voltage level.

SEEM_decrun 860 is a SEEM component executing tasks similar to SEEM_init and SEEM_encrun, handling the tasks dynamically as needed while the codec system is in decode running state 385. SEEM_shut 865 performs an energy conserving system shutdown by appropriately powering off voltages and shutting down clock domains in sequences that do not compromise the systems ability to either switch back on at a later time or respond to a sudden request to reverse the shut-down process.

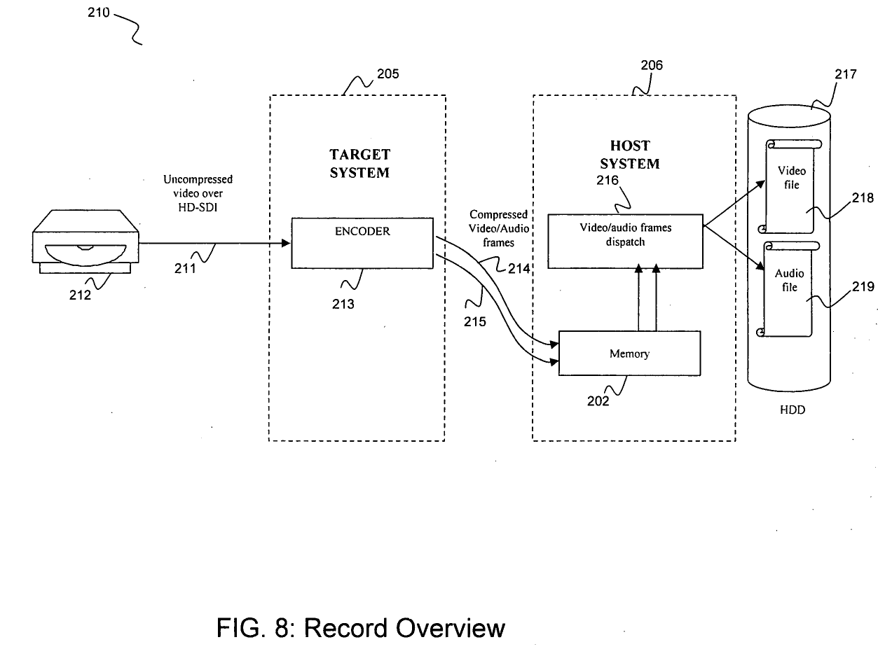

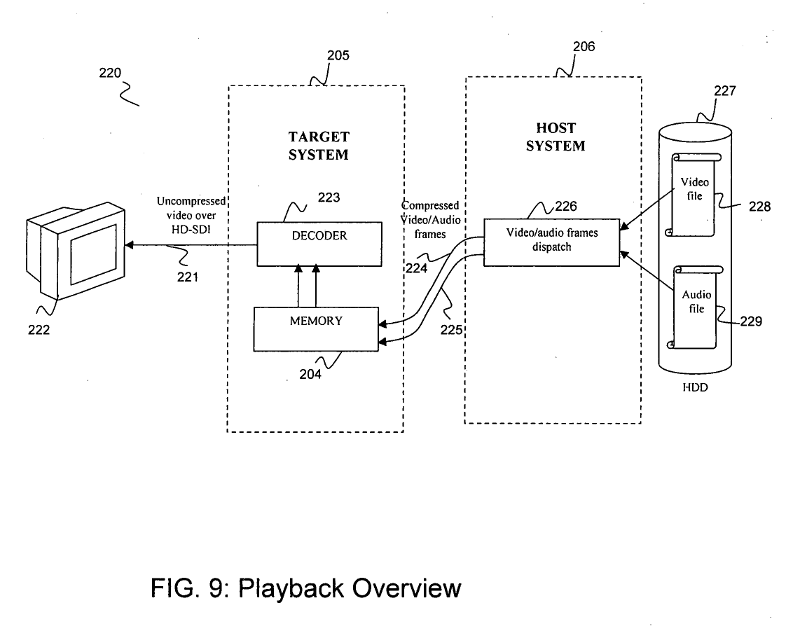

Once the codec system has appropriately been initialized and configured via the PCI manager, there are two essential user modes of operation shared between the host and codec system—the record mode and the playback mode. FIGS. 8 and 9 are used to describe these two modes.

FIG. 8 is a block diagram of record function 210. Following the flow of data from left to right, a video/audio source 212, such as a DVD drive or HDTV camera sends an uncompressed HD-SDI transport stream 211 to the codec system (target) 205 which is configured to operate encoder 213. Encoder 213 encodes and compressed video stream 211 into encoded/compressed video stream 214 and audio stream 215. The streams 214 and 215 are written to shared memory 202 contained in host system 206 where the video and audio data is then stored by dispatch module 216 to video file 218 and audio file 219, respectively, on storage media device 217. Shared memory 202 is available to be written directly by the codec encoder 213 via direct memory access functions of the PCI bus in the preferred embodiment of the present invention.

FIG. 9 is a block diagram of the playback function 220. Following the flow of data from right to left, a video file 228 and audio file 229 is contained in storage media 227, the storage media being attached to host system 206. Video and audio data is retrieved by dispatch module 226 and transmitted as video stream 224 and audio stream 225 from host system 206 and stored into shared memory 204 contained within codec system 205 (target). Furthermore, codec system 205 is programmed to operate decoder 223 which decodes stored video and audio data from streams 224 and 225, respectively and outputs the decoded video and audio signals as an uncompressed HD-SDI transport stream 221 which is further displayed by video display device 222. Shared memory 204 is available to be written directly by the host system 206 via direct memory access functions of the PCI bus in the preferred embodiment of the present invention.

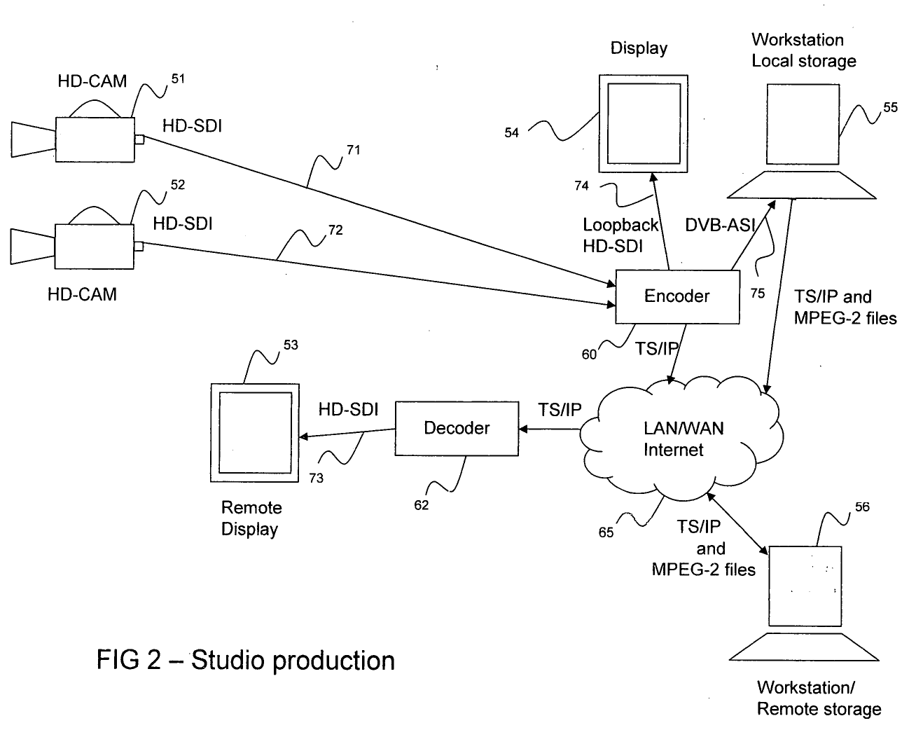

A second embodiment of the present invention is a production quality stand-alone codec system suitable for rack mount applications in a studio or video production environment. FIG. 2 shows stand-alone (SA) encoder 60 and stand-alone (SA) decoder 62 which may be separated physically from each from other or mounted in the same rack. Both SA encoder 60 and SA decoder 62 are connected to LAN/WAN IP routed network 65 which itself may be a part of the internet IP routed network. HD-camera 51 and HD-camera 52 output uncompressed HD-SDI signals 71 and 72, respectively on 75-ohm video cables, respectively, which are connected as input HD-SDI signals to SA encoder 60. A loopback HD-SDI signal 74, which is a copy of at least one of the raw uncompressed video signals 71 or 72, may be displayed on a first HD video monitor 54.

SA encoder 60 functions to encodes and compress at least one of the HD-SDI signals 71 and 72 into an MPEG-2 transport stream which may be further packetized into a DVB-ASI output signal 75 or a an MPEG-2 TS over IP packet stream which is sent to IP routed network 65 for transport to other devices such as SA decoder 62 and video workstation 56. SA decoder 62 may be used to monitor the quality of the MPEG-2 encoding process by decoding the MPEG-2 TS over IP packet stream to uncompressed HD-SDI signal 73 which is available for viewing on a second HD video display monitor 53. Video workstation 56 receives routed MPEG-2 TS over IP packet streams and may by used to display, edit, store and perform other video processing functions as is known in the art of video production.

One goal of the present invention is to provide SA encoder and SA decoder devices which are customized for the needs of the specific production environment. As production environment needs vary considerably from company to company and requirements evolve rapidly with standards, a need exists for software programmable SA encoder and decoder devices allowing for rapid development and deployment cycles.

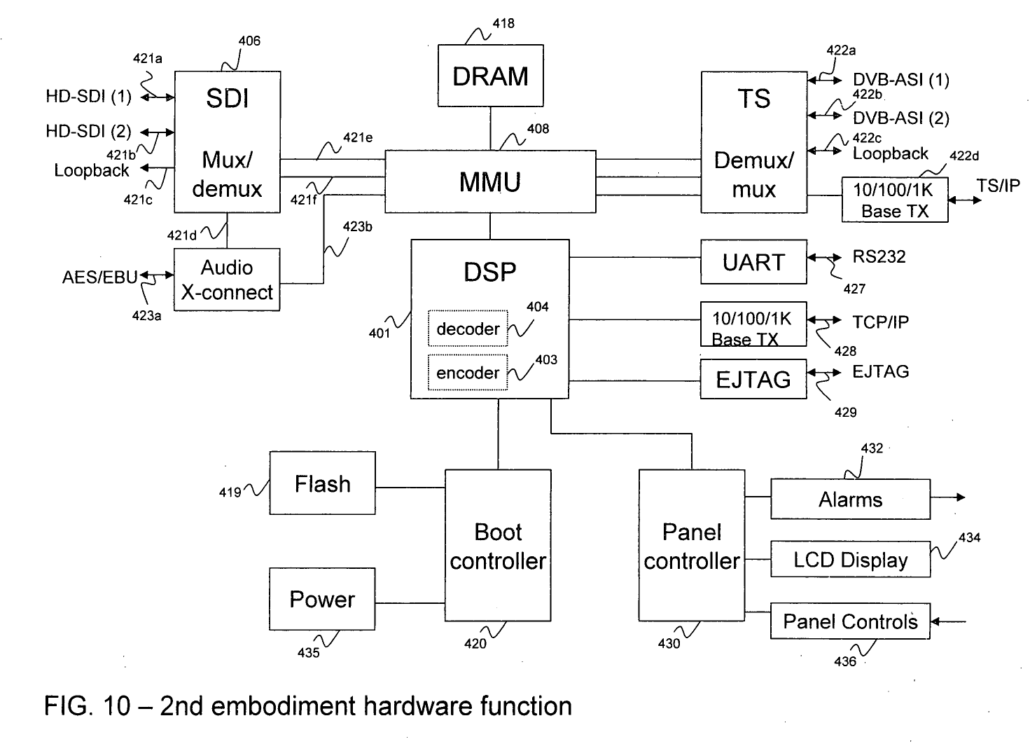

FIG. 10 shows a functional diagram of codec system 400 of the second embodiment of the present invention which is very similar to first embodiment codec system 300 except that interfaces to a host system are replaced with panel control interfaces. Codec system 400 comprises a DSP microprocessor 401 to which memory management unit MMU 408, a SDI mux/demux 406, a transport stream (TS) mux/demux 410 and an audio crossconnect 412 are attached for processing video and audio data streams. DSP microprocessor 401 implements video/audio encoder functions 404 and video/audio decoder functions 403. DSP microprocessor 401 has interfaces RS232 PHY interface 427 and 10/100/1000 Base-Tx Ethernet interface 428 for external control, EJTAG interface 429 for hardware debugging and a panel controller 430 for controlling front panel functions including alarms 432, LCD panel display 434 and panel control keypad 436. Boot controller 420 is included to provide automatic bootup of the hardware system, boot controller 420 being connected to flash memory 419 which holds program boot code, encoder functional code and decoder functional code which may be executed DSP microprocessor 401. Power on/off switch 435 is sensed by boot controller 420 which controls the codec system shutdown and turn on processes.

DSP microprocessor 401 is a physical integrated circuit with CPU, 1/0 and digital signal processing hardware onboard. A suitable component for DSP microprocessor 401 having sufficient processing power to successfully implement the embodiments of the present invention is the SP16 Storm-1 SoC processor from Stream Processors Inc.

MMU 408 provides access to dynamic random access memory (DRAM 418) for implementing video data storage buffers utilized by SDI mux/demux 406 and TS mux/demux 410 for storing input and output video and audio data. SDI mux/demux 406 has external I/O ports HD-SDI port 421a, HD-SDI port 421b, HD-SDI loopback port 421c, and has internal I/O connections to DRAM 418 through MMU 408 including embedded video I/O 421e and embedded metadata I/O 421f. SDI-mux/demux may stream digital audio to and from audio crossconnect via digital audio I/O 421d. A set of external AES/EBU audio ports 423a-d also connected to audio crossconnect 412 functions to select from the signal on audio ports 423a-d or the signal on digital audio I/O port 421d for streaming to DRAM 418 through MMU 408 on embedded audio connection 423b.

Transport stream mux/demux 410 has DVB-ASI interfaces 422a, 422b and DVB-ASI loopback interface 422c. TS mux/demux 410 may also generate or accept TS over IP data packets via 10/100/1000 Base-Tx Ethernet port 422d. TX mux/demux 410 conveys MPEG-2 transport streams in network or transmission applications. MPEG-2 video data streams may be stored and retrieved by accessing DRAM 418 through MMU 408.

MMU 408, SDI mux/demux 406, TS mux/demux 410 and audio crossconnect 412 functions are preferably implemented in programmable hardware such as a field programmable gate array (FPGA). Encoder and decoders are implemented in reprogrammable software running on DSP microprocessor 401. Boot controller 420 and panel controller 430 are implemented as system control programs running on DSP microprocessor 401.

The encoder and decoder implementations as well as the software framework for second embodiment codec system 400 are similar to the implementations and framework for first embodiment codec system 300. Software framework for the second embodiment replaces PCI manager with a panel control manager and extended codec manager for controlling alarming functions and the human interface functions: LCD panel display functions and panel control functions. Buttons on the front display panel are used to change the operational mode of second embodiment codec system, a codec manager software component being the primary system component responsible to communicate with the front panel display. Software state diagram as described for first embodiment codec system also applies to second embodiment codec system.

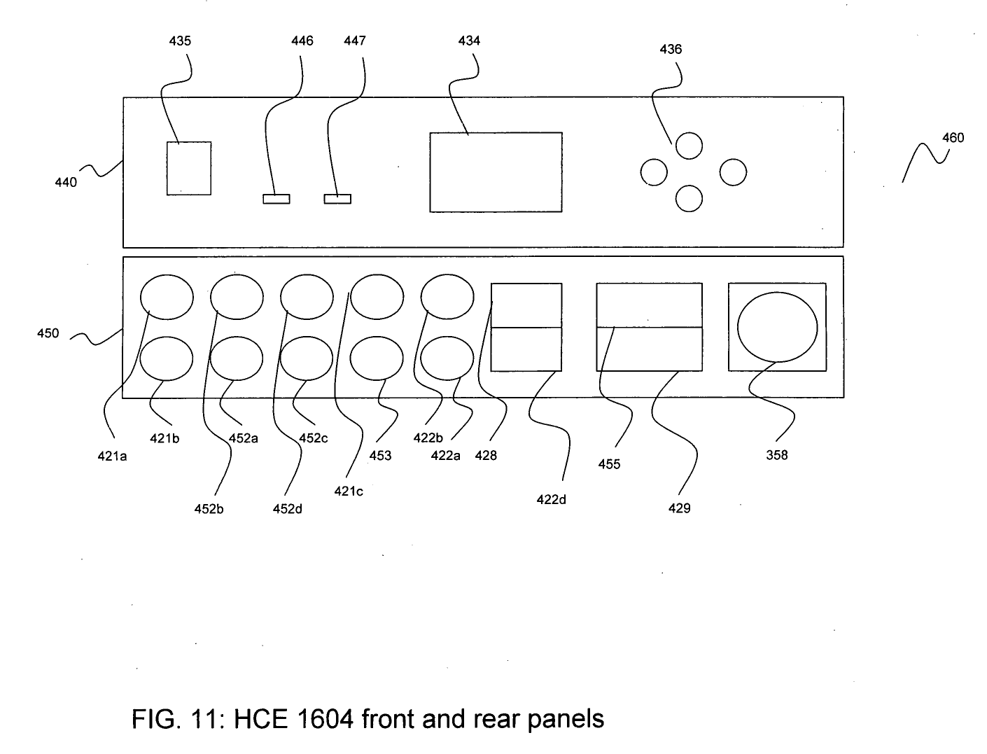

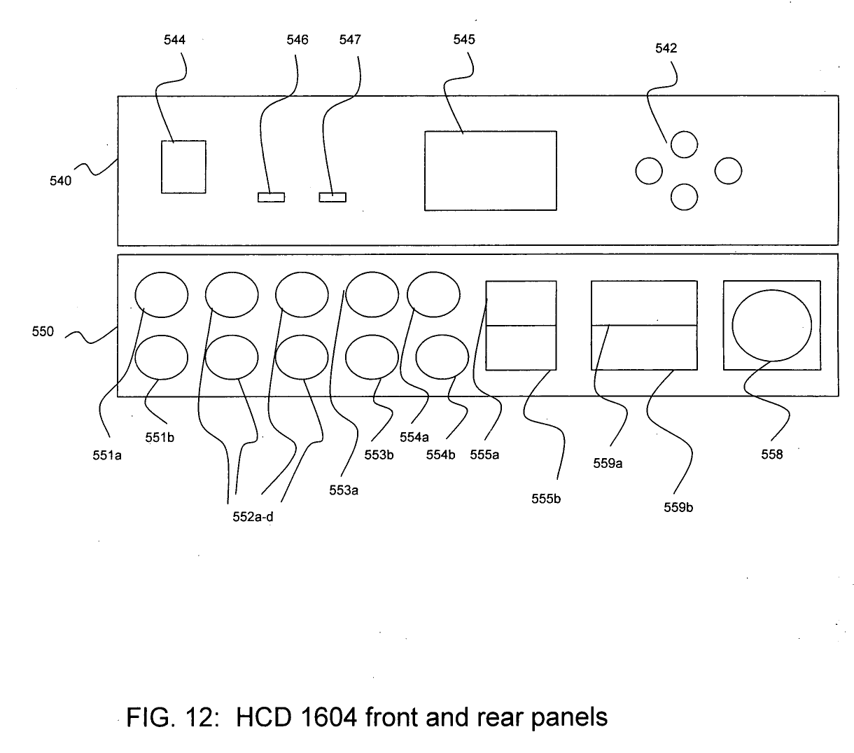

FIG. 11 provides further description of an encoder box 460 which embodies the hardware functions of codec system 400 programmed to implement a video and audio encoder. FIG. 12 provides further description of a decoder box 560 which embodies the hardware functions of codec system 400 programmed to implement a video and audio decoder. The encoder box 460 and decoder box 560 are realized in the HCE1604 encoder and HCD1604 decoder, respectively, from Ambrado Inc.

A picture of the encoder box 460 front and back panels are shown in FIG. 11; the housing to which the front panel 440 and back panel 450 are attached is a metal box with dimensions X by Y by Z. Front panel 440 contains LCD panel display 434 that can be used to preview uncompressed input video. LCD panel display 434 also serves to display menu options which are controlled by means of panel control keypad 436 buttons (up/down/Enter/Escape). Encoder box 460 is configured via panel control keypad 436 or configured remotely via dedicated 10/100/1000 Mbps Ethernet port 428 using SNMP, Telnet based CLI and web based interface implemented in the system OS of DSP microprocessor 401. Encoder box 460 is further programmed to support collection and storage of information such as event logs of alarms, warnings and statistics of transmitted packets. Encoder box 460 is powered by a DC power supply which plugs into the back DC power port 458 requiring a voltage range of 10.5V to 20V, 12V nominal; power on/off switch 435 is on the front panel.

Encoder box 460 supports a real time clock to keep track of its event logs, alarms and warnings; to maintain synchronization, the encoder box has a clock reference input 453. Event log data is saved in onboard flash memory and is available for user access. Ethernet 10/100/1000 Base-tx IP management port 428 is available on rear panel 450 for remote management of encoder functions. Encoder box 460 also has debug port 429 to connect to a local interface such as an EJTAG interface for hardware debugging and has a parallel alarm port 455 for remote monitoring of alarm signals 432. For local monitoring of alarm signals 432, front panel 440 contains alarm light 446 and status light 447. Encoder box 460 and decoder box 560 are half-rack in size so two boxes can be mounted in a single slot in any desired combination, for example one encoder box 460 and one decoder box 560.

Encoder box 460 has two HD/SD SDI I/O ports 421a and 421b for uncompressed video with embedded audio. One of the two HD/SD SDI signals on HD-SDI I/O ports 421a or 421b is selected for video/audio encoding and the selected HD/SD SDI signal is then driven to HD/SD SDI loop back I/O port 421c. Additionally, 4-pairs (8-channel) of external AES/EBU input audio signals 423a are connected via rear panel BNC connectors 452a-452d. Encoder box 460 is programmed to support the generation of color bars and a 1 KHz sine test signals for video and audio processing, respectively.

For output, encoder box 460 has two DVB-ASI I/O ports 422a and 422b providing two identical outputs for transmission of the DVB-ASI compliant MPEG Transport Stream (TS). Encoder box 460 allows for transmission of MPEG-2 TS over IP through dedicated 10/100/1000 Mbps (Gigabit) Base-TX Ethernet port 428. SDI and DVB video and AES/EBU audio ports typically utilize 75-ohm BNC type connectors. The Ethernet ports typically use RJ-45 connectors.

Similar to encoder box 460, decoder box 560 has front panel and rear panel connectors and controls. FIG. 12 shows the front panel 540 and rear panel 550 of a decoder box 560 having a chassis (not shown) of similar size to the encoder box 460. Front panel 540 includes power on/off switch 544, alarm light 546, status light 547, LCD display panel 545 and panel control keypad 542 all of which interact with the codec system 400 programmed to function as a decoder. On the rear panel, the DC power is connected through DC-in jack 558. DVB-ASI input signals are connected through BNC connectors 554a and 554b with DVB-ASI loopback port connected through BNC connector 553a. A reference clock may be connected to BNC connector 553b. Four channel AES/EBU audio signals are output on BNC connectors 552a-552d. After decoding the input MPEG-2 transport streams on DVB-ASI input signals, decoder box 560 outputs uncompressed HD-SDI standard SMPTE 292M signals on BNC connectors 551a and 551b. For remote management and control, a 10/100/1000 Base-TX IP Ethernet port 555a is provided on an RJ-45 connector, a set of digital alarm signals are made available on parallel connector 559a. A serial debug port 559b compatible with EJTAG is also provided. MPEG-2 TS over IP may be connected through 10/100/1000 Base-TX Ethernet port 555b for streaming of TS IP packets to a routed network.

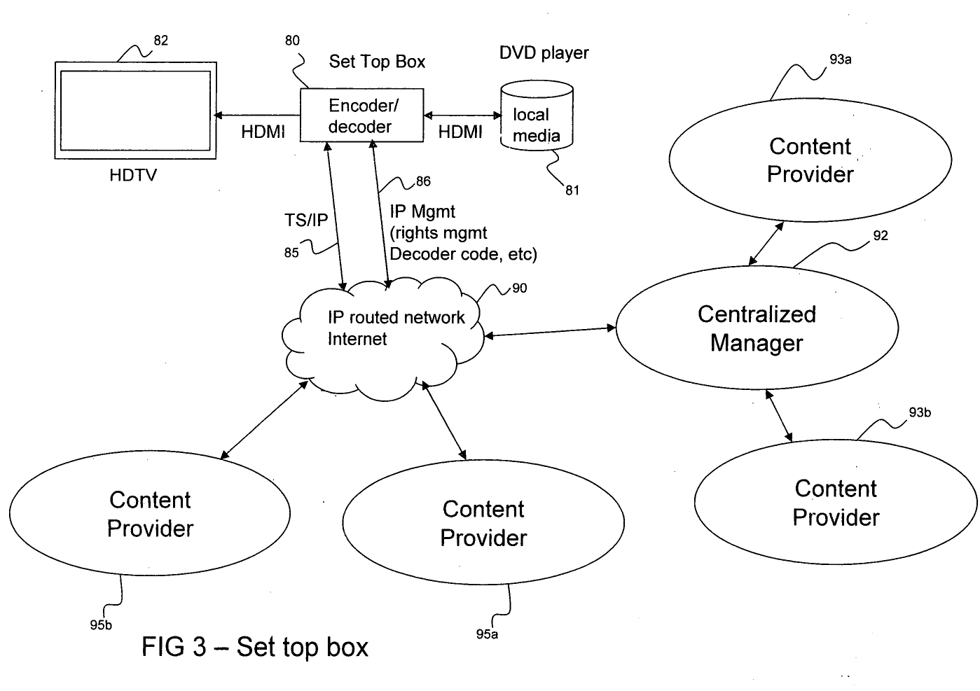

Another set of applications with a corresponding third embodiment of the present invention relates to the consumer market for home theater and digital television systems. Third embodiment of the present invention, shown in FIG. 3, is a set top box (STB) audio/video decoder system comprising STB decoder 80 connected to an HDTV television 82, local media player also connected to STB decoder 80, and internet IP routed network 90 via TS IP link 85 and IP management link 86. A centralized STB manager 92 is connected by internet to STB decoder 80. Centralized STB manager may be further connected to local content from a plurality of content providers 93a and 93b. Other content providers 95a and 95 may be connected directly to STB decoder box to stream content via the internet IP Routed network 90 and TS IP link 85 or to establish rights management for media being accessed from local media player 81 via IP management link 86. One novel function of the present invention is the capability of the STB decoder 80 to have a content specific decoder downloaded on IP management link 86 from centralized manager 92 or from content providers 95a and 95b. STB decoder 80 is connected to local media player 81 which may be a digital video disc player, such as a Blu-ray disc player, or a local hard drive in combination with a computer system. STB decoder 80 decodes the transport stream generated by local media player 81; the transport stream, which may be a H.264 or MPEG-2 transport stream, is typically communicated to the decoder via HDMI interface. The transport stream is decoded by STB decoder 80 into an HDTV signal suitable for HDTV television 82. Alternatively, a video on demand (VOD) system may operate to send a video TS over IP 85 to STB decoder 80 for decoding and display on HDTV television 82.

The STB codec system comprises a number of hardware programmable and software programmable blocks in addition to some static fixed function blocks to accomplish video decoding functions. The video decoding functions may be altered to implement a given set of video standards at any given time through programmability. In the context of the third embodiment STB decoder, a further novel element of the present invention is the capability of the codec system to be field programmable via remote IP network which allows for decoder functions to be indexed to specific content and downloaded remotely on demand and based on selected content.

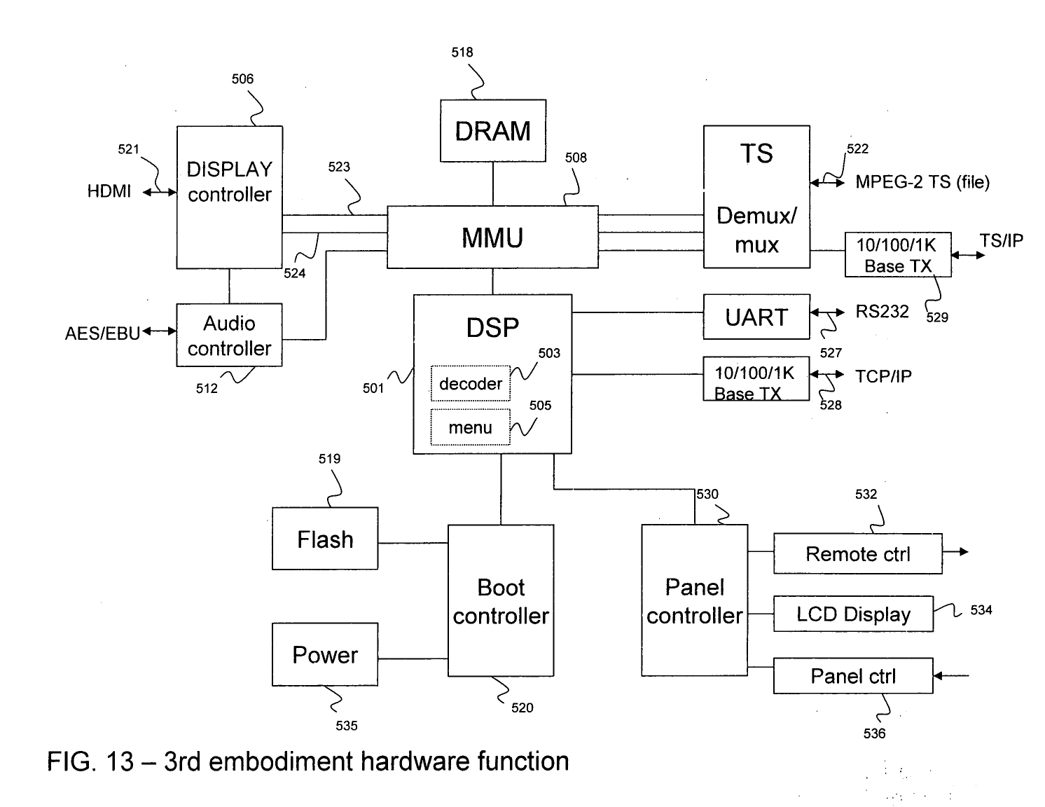

FIG. 13 shows a functional diagram of codec system 500 of the second embodiment of the present invention which is very similar to second embodiment codec system 400 except that video and audio interfaces to and from external devices are replaced with commercial oriented HDMI interfaces and a user interface is accomplished through television display. Codec system 500 comprises a DSP microprocessor 501 to which memory management unit MMU 508, a display controller 506, a transport stream (TS) mux/demux 510 and an audio controller 512 are attached for processing video and audio data streams. DSP microprocessor 501 implements video/audio decoder functions 503 and user menu functions 505. DSP microprocessor 501 has interfaces RS232 PHY interface 527 and 10/100/1000 Base-Tx Ethernet interface 528 for external control by LAN and a panel controller 530 for controlling front panel functions including remote control device interface 532, LCD panel display 534 and panel control keypad 536. Boot controller 520 is included to provide automatic bootup of the hardware system, boot controller 520 being connected to flash memory 519 which holds program boot code and decoder functional code which may be executed DSP microprocessor 501. Power on/off switch 535 is sensed by boot controller 520 which controls the codec system shutdown and turn on processes.

DSP microprocessor 501 is a physical integrated circuit with CPU, I/O and digital signal processing hardware onboard. A suitable component for DSP microprocessor 501 having sufficient processing power to successfully implement the embodiments of the present invention is the SP16 Storm-1 SoC processor from Stream Processors Inc.

MMU 508 provides access to dynamic random access memory (DRAM 518) for implementing video data storage buffers utilized by display controller 406 and TS mux/demux 510 for storing input and output video and audio data. Display controller 506 has external HDMI I/O port 521 and has internal I/O connections to DRAM 518 through MMU 508 including embedded video I/O 523 and embedded metadata I/O 524. A set of external AES/EBU audio ports 423a-d are also connected to audio controller 512 for connection to external audio system.

Transport stream mux/demux 510 has HDMI interface 522 and 10/100/1000 Base-Tx Ethernet interface 529. TX mux/demux 510 conveys IEC/ISO compliant MPEG-2 transport streams in network applications over Ethernet interface 529. MPEG-2 video data streams is stored and retrieved on DRAM 518 through MMU 508. In consumer based home environment, HDMI interface 522 may be connected to HD BLU-ray drive, for example, to playback a selected program on the drive. Alternatively, an HD program may be streamed via internet to Ethernet interface 529 for playback.

MMU 508, display controller 506, TS mux/demux 510 and audio controller 512 functions are preferably implemented in programmable hardware such as a field programmable gate arragy (FPGA). Decoder 503 is implemented in reprogrammable software running on DSP microprocessor 501. Boot controller 520 and panel controller 530 are implemented as system control programs running on DSP microprocessor 401.

Decoder implementation and the software framework for third embodiment codec system 500 are similar to the implementation for first and second embodiment codec systems 300 and 400. Software framework for the third embodiment replaces PCI manager with a panel control manager and extended codec manager for controlling alarming functions and the human interface functions: TV display interface functions, remote control interface functions, LCD panel display functions and panel control functions. Remote control 532 in combination with TV display interface functions are used to change the operational mode of third embodiment codec system. Alternatively, the operational mode may be programmed using LCD panel display 534 and panel control keypad 536. Software state diagram as described for first embodiment codec system also applies to third embodiment codec system.

Turning now to the algorithms used for encoding in the codec systems of the present invention, the video encoding function may include at least the functions of performing discrete cosine transforms (DCT), applying a quantization matrix (Q) to the DCT signal, applying a variable length coding (VLC) to the quantized signal, and formatting the output signal into a transport stream (TS). An important feature of the embodiments of the present invention is the capability to run the video encoder in a constant bit stream mode.

A constant bit stream is accomplished through methods including at least the method of programming the video compression function to adjust quantization matrix scale factors on-the-fly and per image slice. The hardware system and programmability allows methods of compression and rate control to be optimized on-the-fly for a given application environment. Furthermore, improvements in the encoding function in general may be made over time and incorporated through program updates via the flash memory.

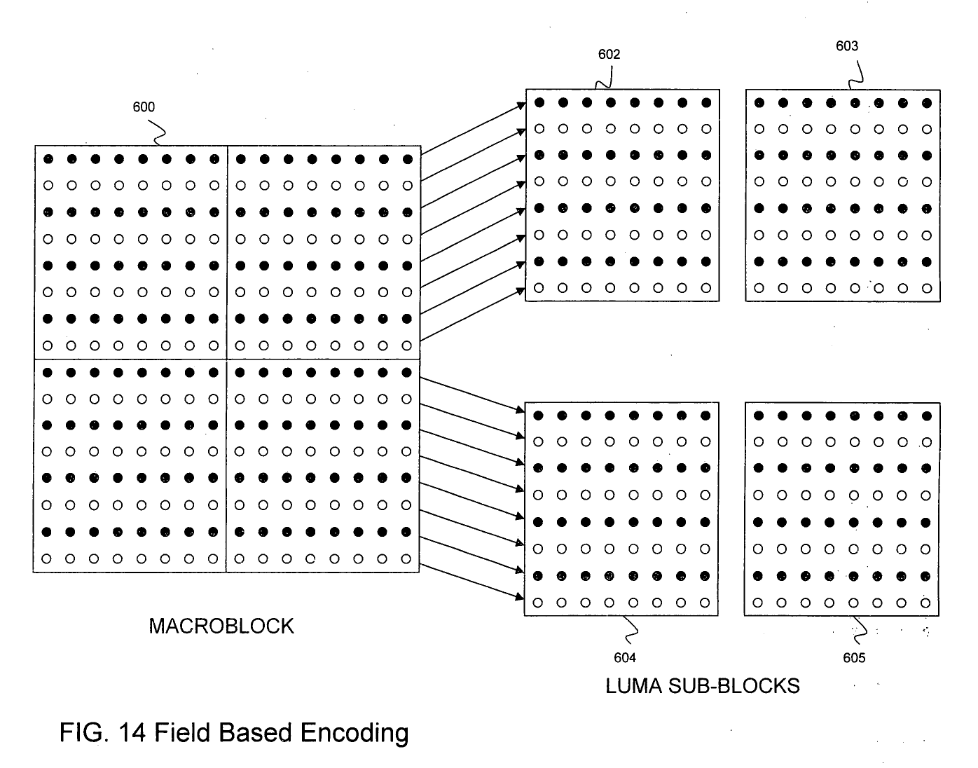

FIG. 14 is a drawing depicting luma samples of a video image consistent with interlaced framed pictures. The field based encoder method is useful for encoding a frame-structured MPEG2 picture from an interlaced source. A 16×16 macroblock 600 comprises 16 rows and 16 columns with luma samples of alternate odd rows depicted by black dots and luma samples of alternate even rows depicted by open dots. The 16×16 macroblock is further partitioned into 4 8×8 sub-blocks. A first luma sub-block 602 s constructed by combining the odd rows of the leftmost two 8×8 sub-blocks. A second luma sub-block 603 is constructed by combining the odd rows of the rightmost two 8×8 sub-blocks. A third luma sub-block 604 is constructed by combining the even rows of the leftmost two 8×8 sub-blocks. A fourth luma sub-block 605 is constructed by combining the even rows of the rightmost two 8×8 sub-blocks.

The field based encoder of the preferred embodiment operates separately on the 8×8 luma subblocks 602, 603 604 and 605, applying DCT, quantization matrix and VLE methods thereto.

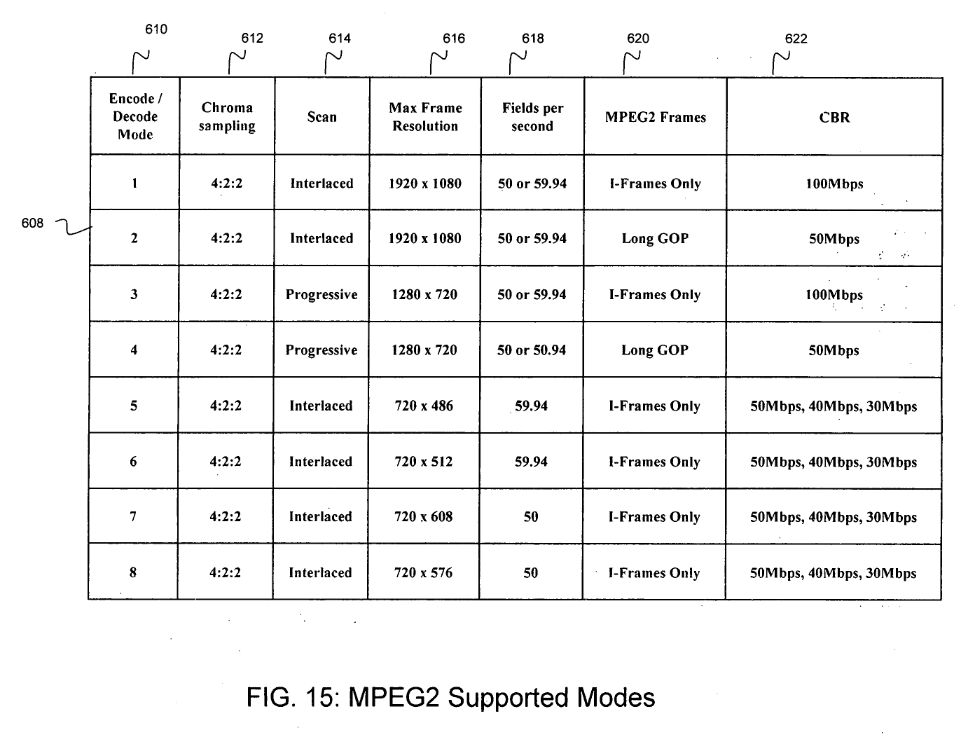

Examples of some preferred encoder modes as supported in the current embodiments are shown in the table 608 of FIG. 15, each encoder mode 610 producing a corresponding CBR bit rate 622 of 100 Mbps, 50 Mbps, 40 Mbps or 30 Mbps. Complete MPEG-2 frames 620 are constructed from interlaced or progressively scanned fields 614 containing a plurality of subblocks assembled into I-frames or long GOP (group of pictures) by the codec, the frames having corresponding resolutions 616. Field sampling rates 618 for each indicated encoder mode are also given in table 608. A preferred 4:2:2 chroma sampling scheme 612 is shown for the indicated encoder modes although additional samplings schemes and additional encoder modes may be supported.

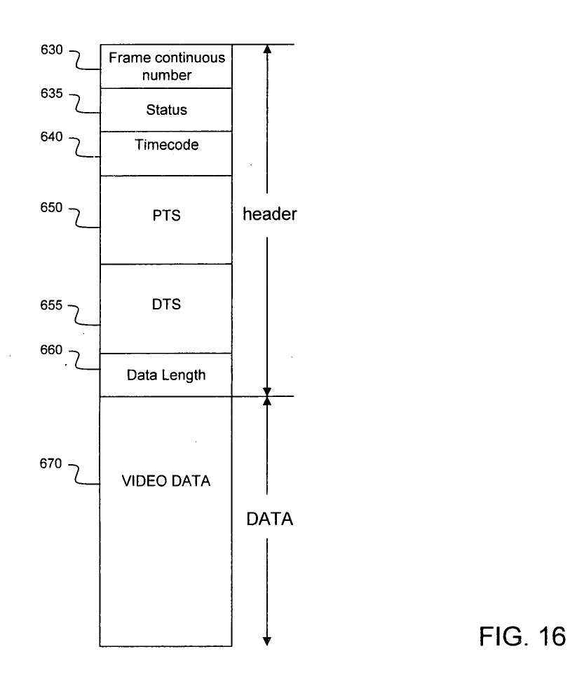

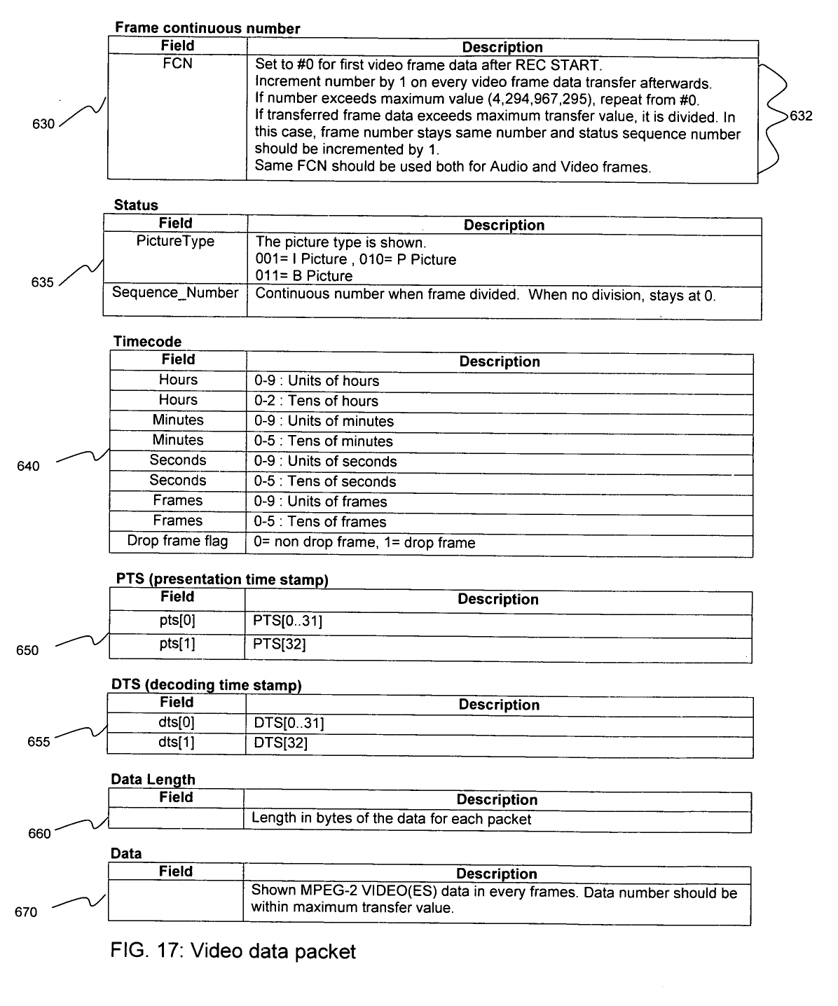

Upon encoding each complete frame into an MPEG-2 elementary transport stream, each transport stream packet record is augmented with a record header according to the record header format shown in FIGS. 16 and 17. Once the record header is packed, each frame is ready to be transported away, for example, to a host processor for storage or to an IP router for transport to another device on a routed network.

FIG. 16 indicates the fields of the record header: Frame continuous number 630, status 635, timecode 640, presentation time stamp (PTS) 650, decoding time stamp (DTS) 655, data length 660. Video data section 670 follows the record header. In alternate embodiments, audio data and metadata may also be included in video data section 670.

FIG. 17 shows the detailed record structure in the current embodiments. Frame continuous number FCN 630 is an index that increments on every frame transferred. Status 635 comprises two fields having a picture type selected from the set of (I Picture, P Picture and B Picture) and having a sequence number for further frame indexing. Method 632 indicates how FCN 630 is computed. For the first video frame after REC START, FCN is set to 0 (zero) and Status sequence_number is set to 0 (zero). FCN is incremented by 1 (one) on every video frame transfer thereafter. If the FCN exceeds a maximum (4,294,967,295 in the current embodiment), FCN starts incrementing from 0 (zero) again and Status sequence_number is incremented by 1.

Timecode 640 comprises 9 fields indicating hours, tens of hours, minutes, tens of minutes, seconds, tens of seconds, frames, tens of frames and a frame drop flag. PTS 650 has two fields containing the presentation time stamp in standard timestamp format. DTS 655 has two fields containing the decoding time stamp in standard timestamp format. Data length 660 indicates the length in bytes of the size of the packet. Video data section 670 contains MPEG-2 video transport stream data in the preferred embodiment.

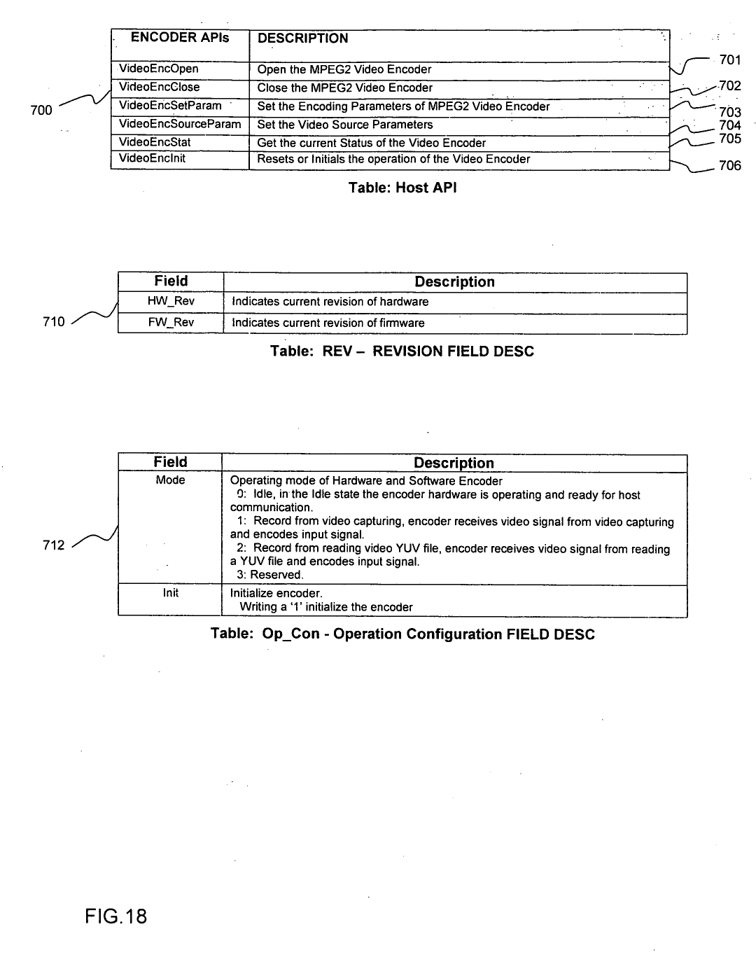

A host software API in the context of the first embodiment codec system is specified for communications between the host and the encoder. Communications occurs by reading and writing commands and other information to specified memory locations (fields) which are shared between host and codec across the PCI bus interface. Table 700 of FIG. 18 shows a preferred set of API commands recognized and supported by the codec system, the set of API commands including commands to open a stream to the MPEG2 video encoder (command 701); close a stream to the MPEG2 video encoder (command 702); set the encoding parameters of the MPEG2 video encoder (command 703); set the video source parameters (command 704); get the current status of the video encoder (command 705); and to initialize the operation of the video encoder firmware and software (command 706).

The host software API may access or set encoder information. The function of reporting the current hardware and firmware revision is reported by two fields HW_rev and FW_rev as per table 710.

The host software API may read or write the operational configuration which is accomplished through a set of fields shown in table 712 as operating “Mode” field and operating “Init” field as per table 712. The operating “Mode” of the MPEG2 video encoder is set to one of four possible operating modes: mode 0 being an “idle” mode in which the encoder hardware is operating and ready for communication from the host; mode 1 being a “record from video capturing” mode wherein the encoder receives signal from an HD-SDI video stream and is capturing and encoding the video stream into the elementary transport stream; mode 2 being a “record from video YUV data file” mode wherein the encoder receives video signal from reading a YUV data file which is buffered in shared memory and encodes the file into an elementary transport stream. Operating “Init” field causes an initialization of the encoder firmware if the field value is set to ‘1’.

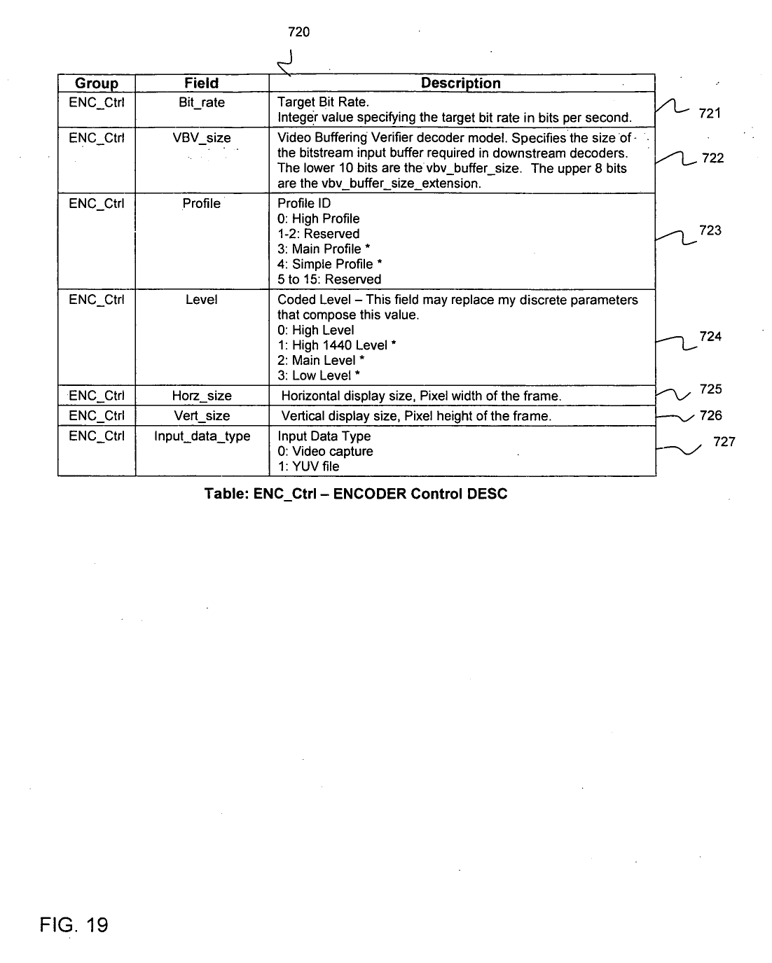

According to FIG. 19, host software API support functions include control and status parameters read and written to a set of control fields as per table 720. A “bit rate” field 721 sets the target CBR bit rate according to value of bits per second. A “VBV_size” field 722 sets the video buffering verifier decoder model specifying the size of the bitstream input buffer required in downstream encoders. A “profile” field 723 sets the MPEG2 profile type to one of (High Profile, Main Profile, and Simple Profile) and may include other MPEG profiles in alternate embodiments. A “level” field 724 sets the MPEG2 coded level to one of (High Level, High 1440 Level, Main Level, and Low Level). A “Horz_size” field 725 sets the pixel width of the encoded video frame. A “Vert_size” field 726 sets the pixel height of the encoded video frame. An “input_data_type” field 727 sets the input data to one of (Video capture, and YUV data file) which may be expanded to more input data sources as required by the codec hardware and application environment.

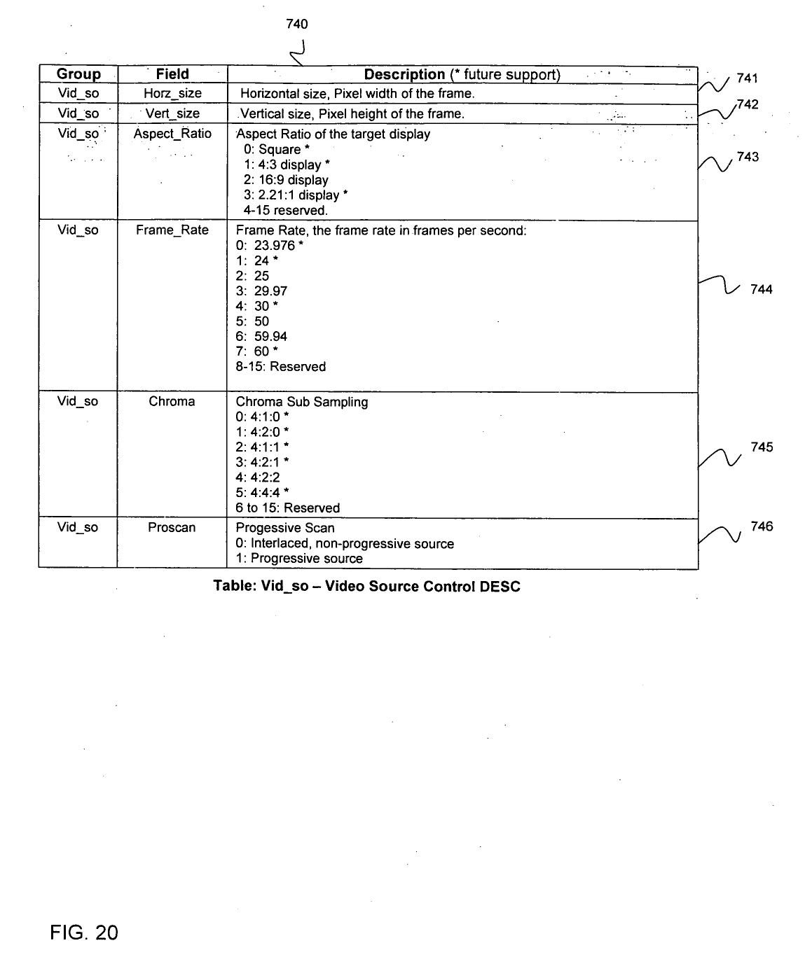

According to FIG. 20, host software API support functions may include the setting of information regarding the video source and is accomplished through the setting of fields as shown in Table 740. A “horz_size” field 741 specifies the pixel width of an incoming video frame. A “vert_size” field 742 specifies the pixel height of the incoming video frame. An “aspect_ratio” field 743 specifies the aspect ratio of the target display device to be one of (Square, 4:3, 16:9, 2.21:1) with reserved bit values for other aspect ratios. A “frame_rate” field 744 specifies the number of frames per second in the video stream according to the list (23.976, 24, 25, 29.97, 30, 50, 59.94, 60) frames per second with reserved bit values for other possible frame rates. A “chroma” field 745 specifies the chroma sub-sampling scheme according to the list (4:1:0, 4:2:0, 4:1:1, 4:2:1, 4:2:2, 4:4:4) and reserved bit values for other schemes that may become important in future applications. A “proscan” field 746 specifies whether the video signal is a progressive scan type signal or an interlaced type signal.

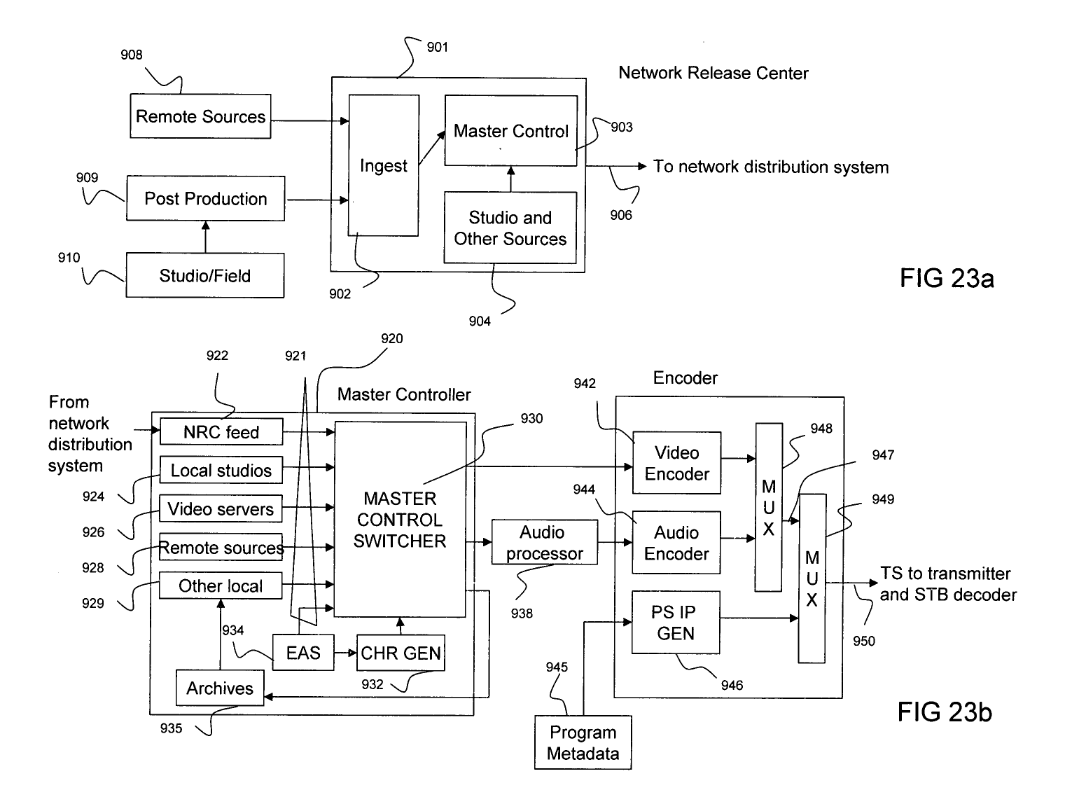

Another illustrative embodiment of the flexibility of the codec system of the present invention is explained with the help of FIGS. 23a and 23b and in the context of the third embodiment set top box decoder application shown in FIG. 3. Content provider 93a of FIG. 3 may include a network release center (NRC) similar to NRC 901 of FIG. 23a. NRC 901 comprises an ingest processing engine 902, a master control switcher 903 and internal sources of video data 904. Off-site sources of video data include remote sources 908 and video created in the post production process 909 which takes raw video directly from production studios 910. Master control switcher 903 provides a channelized video output signal 906 which is typically sent as channelized MPEG-2 encoded transport streams to satellite uplink stations for distribution to network head ends throughout a nationwide or worldwide network.

FIG. 23b shows a network head end arrangement comprising a master controller 920 and encoder 940, with the master controller 920 deriving video from various video sources including NRC feeds 922, local studios 924 such as local news production centers, video servers 926 for supplying video-on-demand to consumers, an emergency alert system (EAS) 934 generating video, audio and closed captioning 932, other remote sources 928 such as pay per view programming, and other local sources 929 such as local sports venues, churches, and offsite produced video include the local station archives 935. Master controller 920 has a master control switcher 930 for channelizing and switching feeds 921 from the various video sources. Feeds 921 include video signals and audio signals, some of which are encoded and others which are raw HD-SDI or other uncompressed formats. Video output is sent directly to encoder 940 while audio output is sent to audio processor 938 for audio pre-processing, the pre-processed audio being sent to encoder 940 for encoding.

Encoder 940 comprises video encoder 942, audio encoder 944, program stream (PS) IP packet generator PS GEN 946, a first multiplexer 948 and a second multiplexer 949. Video encoder 942 and audio encoder 944 encode video and audio output, respectively, from master controller 920. First multiplexer 948 generates elementary transport stream ES 947 generated from video encoder 942 and audio encoder 944. Program metadata 945 is packetized by PS IP GEN 946 and sent to second multiplexer 949 to be combined with ES 947 into broadcast transport stream 950 which is further propagated by cable or other broadcast means to a customer site. A suitable set top box such as the set top box 80 from FIG. 3 exists at the customer site to decode broadcast transport stream 950. Video encoder 942 and audio encoder 944 may operate to pass through signals that were previously encoded by NRC 901.

The flexible codec system of the present invention may be used as encoder 940. As new video formats and new compression algorithms are standardized, for example to reduce bandwidth for HDTV, the flexible codec system including encoder 940 in combination with decoder set top box 80 may be upgraded accordingly. Furthermore, program metadata 945 may include specific decoders or decoder configurations which may be downloaded to set top box 80.

The specifications and description described herein are not intended to limit the invention, but to simply show a set of embodiments in which the invention may be realized. For example, the present invention is equally applicable to embodiments utilizing frame based encoding and decoding in addition to the field based encoding and decoding of the embodiments described herein. Yet other embodiments may be conceived for example, for current and future studio quality video formats which may include 3-D image and video content of current and future consumer formats for in-home theater such as the MPEG-4, H.264 format.

1. A programmable energy managed codec system for encoding an uncompressed video signal on an input port into compressed video signal on an output port comprising:
a. a digital signal processor, operating at a varying operating voltage and a varying clock rate;
b. a memory management unit communicatively connected to the digital signal processor the input port and the output port;
c. a first memory device connected to the memory management unit and in communication with the digital signal processor;
d. a first video transform means, connected to the first memory device through the memory management unit, for transforming the uncompressed video signal into a first video data set residing in the first memory device;
e. a programmable encoder means, operated by the digital signal processor as a set of program instructions residing in the first memory device, for encoding the first video data set into an encoded video data set;
f. a second video transform means, connected to the first memory device through the memory management unit, for transforming the encoded video data into the compressed video signal;
g. a system energy controller operated by the digital signal processor through a set of program instructions residing in the first memory device, the system energy controller programmed to monitor the varying operating voltage, the varying clock rate and the programmable encoder means, the system energy controller further programmed to adjust the varying operating voltage and the varying clock rate based on the set of program instructions; and
h. whereby the uncompressed video signal received on the input port is changed into the compressed video signal on the output port and the energy of the system is managed by the system energy controller.

2. The programmable energy managed codec system of claim 1 further comprising:
a. a housing having connections for a plurality of input video ports and a plurality of output ports;
b. at least one of the plurality of input video ports carrying the uncompressed video signal; and,
c. at least one of the plurality of output ports carrying the compressed video signal.

3. The programmable energy managed codec system of claim 2 wherein at least one of the plurality of output video ports is of a DVB-ASI format.

4. The programmable energy managed codec system of claim 2 wherein at least one of the plurality of output video ports is an ethernet port carrying a transport stream over internet protocol.

5. The programmable energy managed codec system of claim 2 wherein the housing further contains:
a. a panel controller operated by the digital signal processor;
b. an LCD panel communicatively connected to the panel controller;
c. an alarm port connected to the panel controller for signaling of a plurality of alarm conditions; and,
d. a panel control kepad connected to the panel controller.

6. The programmable energy managed codec system of claim 2 wherein the housing further contains:
a. an ethernet port communitively connected to the digital signal processor for remote communications and control with the digital signal processor;
b. a DC power port for supplying power to the system;
c. a system port communicatively connected to the digital signal processor;
d. an audio cross connect in communication with the first video transform means and with the memory management unit; and,
e. a set of audio input ports connected to the audio cross connect.

7. The programmable energy managed codec system of claim 1 wherein the uncompressed video signal is an HD-SDI signal.

8. The programmable energy managed codec system of claim 1 wherein the compressed video signal is an MPEG-2 transport stream.

9. The programmable energy managed codec system of claim 1 wherein the compressed video signal is a H.264 transport stream.

10. The programmable energy managed codec system of claim 1 further comprising:
a. a second memory device connected to the memory management unit; and,
b. a boot controller, connected to the second memory device and operated by the digital signal processor as a set of program instructions residing in the second memory device, programmed to initiate a set of system operations.

11. The programmable energy managed codec system of claim 10 further comprising a host system data interface for transferring data to and from a host system connected to the first memory device.

12. The programmable energy managed codec system of claim 11 wherein the host system data interface is a PCI bus interface.

13. The programmable energy managed codec system of claim 1 further comprising an audio crossconnect for selectably accepting audio data from the uncompressed video signal and from an external audio signal of the AES format.

14. The programmable energy managed codec system of claim 1 wherein the first video transform means of claim 1 further comprising a loopback means for sending a copy of the uncompressed video data to a second output port.

15. A programmable energy managed codec system for decoding a compressed video signal on an input port into an uncompressed video signal on an output port comprising:
a. a digital signal processor operating at a varying operating voltage and a varying clock rate;
b. a memory management unit communicatively connected to the digital signal processor input port and the output port;
c. a first memory device connected to the memory management unit and in communication with the digital signal processor;
d. a first video transform means, connected to the first memory device through the memory management unit, for transforming the compressed video signal to a first video data set residing in the first memory device;
e. a programmable energy managed decoder means, operated by the digital signal processor as a set of program instructions residing in the first memory device, for decoding the first video data set into a decoded video data set;
f. a second video transform means, connected to the first memory device through the memory management unit, for transforming the decoded video data set into the uncompressed video signal;
g. a system energy controller operated by the digital signal processor through a set of program instructions residing in the volatile memory device, the system energy controller programmed to monitor the varying operating voltage, the varying clock rate and the programmable encoder means, the system energy controller further programmed to adjust the varying operating voltage and the varying clock rate based on the set of program instructions; and,
h. whereby the uncompressed video signal received on the input port is changed into the compressed video signal on the output port and the energy of the system is managed by the system energy controller.

16. The programmable energy managed codec system of claim 15 further comprising a housing having connections for:
a. a plurality of input video ports at least one of which carries the compressed video signal; and,
b. a plurality of output video ports at least one of which carries the uncompressed video signal.

17. The programmable energy managed codec system of claim 16 wherein at least one of the plurality of input video ports are of a DVB-ASI format.

18. The programmable energy managed codec system of claim 16 wherein at least one of the plurality of input video ports is an ethernet port carrying a transport stream over internet protocol.

19. The programmable energy managed codec system of claim 16 wherein the housing further contains:
a. a panel controller operated by the digital signal processor;
b. an LCD panel communicatively connected to the panel controller;
c. an alarm port connected to the panel controller for signaling of a plurality of alarm conditions; and,
d. a panel control kepad connected to the panel controller.

20. The programmable energy managed codec system of claim 16 wherein the housing further contains:
a. an ethernet port communitively connected to the digital signal processor for remote communications and control with the digital signal processor;
b. a DC power port for supplying power to the system;
c. a system port communicatively connected to the digital signal processor;

21. The programmable energy managed codec system of claim 15 wherein the uncompressed video signal is of a HD-SDI format.

22. The programmable energy managed codec system of claim 15 wherein the uncompressed video signal is of a HDMI format.

23. The programmable energy managed codec system of claim 15 wherein the compressed video signal is of a MPEG-2 transport stream format.

24. The programmable energy managed codec system of claim 15 wherein the compressed video signal is of a H.264 transport stream format.

25. The programmable energy managed codec system of claim 15 further comprising:
a. a second memory device connected to the memory management unit; and,
b. a boot controller, connected to the second memory device and operated by the digital signal processor as a set of program instructions residing in the second memory device, for initializing the operations of the system.

26. The programmable energy managed codec system of claim 15 further comprising a host system data interface for transferring data to and from a host system connected to the first memory device.

27. The programmable energy managed codec system of claim 26 wherein the host system data interface is a PCI bus interface.

28. The programmable energy managed codec system of claim 15 further comprising:
a. a first audio transform means contained within the first video transform means for demultiplexing a compressed audio data from the compressed video signal into the first memory device;
b. an audio decoding means for decoding the compressed audio data into an uncompressed audio data residing in the first memory device;
c. a second audio transform means contained within the second video transform means for multiplexing uncompressed audio data into the uncompressed video signal
d. an audio crossconnect which is selectably capable of one of creating an AES format audio signal from the uncompressed audio data or moving the uncompressed audio data from the first memory device to the second audio transform means

29. The programmable energy managed codec system of claim 15 wherein the first video transform means further comprises a loopback means for sending a copy of the compressed video data to a second output port.

30. A programmable energy managed codec system for encoding an uncompressed video signal into a compressed video signal and for decoding the compressed video signal into the uncompressed video signal comprising:
a. a digital signal processor operating at a varying operating voltage and a varying clock rate;
b. a memory management unit communicatively connected to the digital signal processor, the input port and the output port;
c. a volatile memory connected to the memory management unit accessed by the digital signal processor;
d. a non-volatile memory accessed by the digital signal processor;
e. a first video transform processor, connected to the volatile memory through the memory management unit, programmed to transform the uncompressed video signal to and from a first video data set residing in the volatile memory;
f. a second video transform processor, connected to the volatile memory through the memory management unit, programmed to transform the compressed video signal to and from a second video data set residing in the volatile memory;
g. a programmable encoder, operated by the digital signal processor stored as a set of encoder program instructions in the non-volatile memory, programmed to encode the first video data set into the second video data set;
h. a programmable decoder, operated by the digital signal processor stored as a set of decoder program instructions in the non-volatile memory, programmed to decode the second video data set into the first video data set;
i. a codec system controller operated by the digital signal processor as a set of program instructions residing in the volatile memory, the codec system controller programmed to:
i. select from the non-volatile memory one of the group of: set of decoder program instructions and the set of encoder program instructions, as selected program instructions,
ii. loading the selected program instructions into the volatile memory;
iii. causing the digital signal processor to execute the selected program instructions; and,
j. A system energy controller operated by the digital signal processor as a set of energy program instructions residing in the non-volatile memory, the system energy controller programmed to monitor the varying operating voltage, the varying clock rate and the programmable encoder, the system energy controller further programmed to adjust the varying operating voltage and the varying clock rate based on the energy program instructions.

31. The programmable energy managed codec system of claim 30 wherein the uncompressed video signal is an HD-SDI signal.

32. The programmable energy managed codec system of claim 30 wherein the compressed video signal is an MPEG-2 transport stream.

33. The programmable energy managed codec system of claim 30 wherein the compressed video signal is a H.264 transport stream.

34. The programmable energy managed codec system of claim 30 including a network interface means, connected to a remote network resource, for downloading a decoder program instruction set from the remote network resource into the volatile memory and the non-volatile memory.

35. The programmable energy managed codec system of claim 30 including a network interface means, connected to a remote network resource, for downloading the decoder program instructions from the remote network resource into the volatile memory and the non-volatile memory.

36. The programmable energy managed codec system of claim 30 further comprising:
a. a host interface controller communicatively connected to the digital signal processor accessing the volatile memory;
b. a host system, connected to the host interface controller, having a shared memory of accessible through the host interface controller and having a persistent storage memory; and,
c. the host system including a control set having a record function command and a playback function command.

37. The programmable energy managed codec system of claim 36 where the second video data set is stored in the shared memory, the programmable codec system further comprising:
a. a record program stored in the programmable encoder, storing the second video data set in a video file and an audio data file in persistent storage

38. The programmable energy managed codec system of claim 36 wherein the persistent storage contains a video data file and an audio data file, the programmable codec system further comprising:
a. a playback program stored in the programmable decoder, the playback program transferring the video data file and the audio data file to a second video data file residing in the volatile memory.

39. A method for encoding an uncompressed video signal into a compressed video signal in a codec system of components with controlled power usage, comprising the steps of:
a. providing a digital signal processor in the codec system of components;
b. providing a first video transform component in the codec system of components;
c. programming the first video transform component to demultiplex an HD-SDI data stream into an uncompressed audio data stream and an uncompressed video data stream;
d. programming the digital signal processor to perform a first set of encoding functions on the uncompressed audio data stream to convert the uncompressed audio data stream into a compressed audio data stream;
e. programming the digital signal processor to perform a second set of encoding functions on the uncompressed video data stream to convert the uncompressed video data stream into a compressed video data stream;
f. commanding the digital signal processor to perform the first set of encoding functions and second set of encoding functions;
g. storing the compressed audio data stream and the compressed video data stream;
h. providing second video transform component in the codec system of components;
i. programming the second video transform component to multiplex the compressed audio data stream with the compressed video data stream to form a compressed transport stream;
j. providing a power control means, in the codec system of components connected to the digital signal processor, for dynamically monitoring a power consumption of the codec system of components;
k. varying a clock speed of at least one component of the codec system of the components dynamically with the power control means to minimize power usage of the system; and,
l. varying a supply voltage of at least one component of the codec system of components dynamically with the power control means to minimize power usage of the system.

40. The method of claim 39, wherein the steps of programming the first video transferring components and programming second video transform functions are accomplished by programming a field programmable gate array.

41. The method of claim 39 wherein programming the digital signal processor to perform the first and second sets of encoding functions includes the steps of:
a. compiling a set of master encoder programs;
b. storing the set of master encoder programs in a non-volatile memory;
c. choosing one encoder program of the set of master encoder programs based on a format type of the uncompressed video stream and the format type of the compressed video stream.

42. The method of claim 39 wherein programming the digital signal processor to perform the first and second sets of encoding functions includes the steps of:
a. compiling a master set of encoder programs:
b. storing the set of master encoder programs in a remote server on a network;
c. choosing one encoder program of the set of master encoder programs based on the format type of the uncompressed video stream and the format type of the compressed video stream; and,
d. downloading the one encoder program from the remote server.

43. A method for decoding a compressed video signal into an uncompressed video signal in a codec system of components with controlled power usage, the method comprising the steps of:
a. providing a digital signal processor in the codec system of components;
b. providing a first video transform component in the codec system of components;
c. programming the first video transform component to demultiplex an HD-SDI data stream into a compressed audio data stream and an uncompressed video data stream;
d. programming the digital signal processor to perform a first set of decoding functions on the compressed audio data stream to convert the compressed audio data stream into an uncompressed audio data stream;
e. programming the digital signal processor to perform a second set of decoding functions on the compressed video data stream into an uncompressed video data stream;
f. commanding the digital signal processor to perform the first set of decoding functions and second set of decoding functions;
g. storing the uncompressed audio data stream and the uncompressed video data stream;
h. providing second video transform component in the codec system of components;
i. programming the second video transform component to multiplex the uncompressed audio data stream with the uncompressed video data stream to form an uncompressed transport stream;
j. providing a power control means, in the codec system of components connected to the digital signal processor, for dynamically monitoring a power consumption of the codec system of components;
k. varying a clock speed of at least one component of the codec system of the components dynamically with the power control means to minimize power usage of the system; and,
l. varying a supply voltage of at least one component of the codec system of components dynamically with the power control means to minimize power usage of the system.

44. The method of claim 43, wherein the steps of programming the first and second video transform functions is accomplished by programming a field programmable gate array.

45. The method of claim 43 wherein the steps of programming the digital signal processor to perform encoding functions includes the steps of:
a. compiling a master set of decoder programs;
b. storing the master set of decoder programs in a non-volatile memory; and,
c. choosing one decoder program of the master set of decoder programs based on the format types of the uncompressed video stream and the compressed video stream.

46. The method of claim 43 wherein programming the digital signal processor to perform encoding functions includes the steps of:
a. compiling a master set of decoder programs;
b. storing the master set of decoder programs in a remote server on a network;
c. choosing one decoder program of the master set of decoder programs based on the format types of the uncompressed video stream and the uncompressed video stream; and
d. downloading the one decoder program from the remote server.

47. A method for achieving system energy efficiency in a programmable codec wherein the programmable codec has a DSP microprocessor for processing encoder and decoder instructions, memory and a set of peripheral functions for moving video data streams into and out of the programmable codec, and having software programmed components containing the encoder and decoder instructions and containing interfacing instructions for the peripheral functions, the programmable codec operating between an initialization state, a shutdown state, at least one standby state and at least one running state, and a plurality of codec modes the method including the steps of:
a. including a system energy efficiency manager in the software programmed components;
b. predicting processing and memory access requirements by the software programmed components; and,
c. adjusting DSP microprocessor voltage levels and clock speeds and adjusting voltage levels and clock speeds of the peripheral functions in order to reduce power consumption of the programmable codec.

48. The method of claim 47 wherein the step of including a system energy efficiency manager further comprises the steps of:
a. including an energy adjustment component in the software programmed components;
b. the energy adjustment component performing the following steps during codec operation:
i. setting an initial voltage for the DSP microprocessor and the peripheral functions;
ii. setting an initial clock speeds for the DSP microprocessor and the peripheral functions; and,
iii. determining a subset of peripheral functions that are not required by the software programmed components.

49. The method of claim 48 wherein the energy adjustment component further performs the step of:
a. determining a microprocessor voltage and a clock speed of the DSM microprocessor during a state transition from the at least one standby state to the at least one running state.

50. The method of claim 49 wherein the step of determining a microprocessor voltage and a clock speed of the DSP microprocessor includes at least one of the steps of the group of:
a. detecting an I-frame only codec mode;
b. detecting a LGOP frame codec mode;
c. detecting a data transfer intensive codec mode; and,
d. detecting a discrete cosine transform mode.

51. The method of claim 48 wherein the energy adjustment component performs the additional steps of:
a. detecting a shutdown state;
b. if the shutdown state is detected, then performing a shutdown, further including the steps of
i. determining s first time sequences of a voltage turn down;
ii. determining a second time sequence of a clock speed shut down.

52. The method of claim 51 including the additional steps of:
a. evaluating the programmable codec's ability to be turned on; and,
b. evaluating the programmable codec's ability to respond to a transition out of the shutdown state.
